(19) United States
(12) Patent Application Publication
(10) Pub. No.: US 2026/0323615 A1
(43) Pub. Date: Oct. 15, 2026

(54) CONTROL RESOURCE SET TRANSIMISSION

(71) Applicant: LENOVO (BEIJING) LIMITED, Beijing (CN)

(72) Inventors: Yuantao ZHANG, Beijing (CN); Zhi YAN, Beijing (CN)

(21) Appl. No.: 19/490,114

(22) PCT Filed: Jun. 21, 2023
(86) PCT No.: PCT/CN2023/101900

§ 371 Date: Dec. 4, 2025

(51) Int. Cl. H04W 72/0453; H04L 5/00

(52) U.S. Cl. CPC H04W 72/0453; H04L 5/0053; H04L 5/0094

(57) ABSTRACT

Various aspects of the present disclosure relate to control resource set transmission. In one aspect of the solution of the present disclosure, a terminal device receives a configuration of a first CORESET via the transceiver. Based on the configuration and a predefined number of PRBs to be punctured from the first CORESET, the terminal device determines a second CORESET. Based on the configuration, the terminal device determines a mapping type of CCE to REG mapping for the second CORESET. In this way, the CORESET may be punctured into a CORESET with less PRBs in a suitable method for a transmission in narrow bandwidth channels. A mapping type of CCE to REG mapping may be determine for PDDCH transmission. Therefore, the terminal device side implementation effort is eased and the performance of communication is improved.

### TECHNICAL FIELD

The present disclosure relates to wireless communications, and more specifically to apparatuses, processors, methods, and a computer readable medium for control resource set transmission.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

A minimum bandwidth (BW) of 5 MHz channels is defined in Release 15. Although new radio (NR) can support multiple channel bandwidths with flexible numerology, channel bandwidths smaller than 5 MHz are currently not supported. On the other hand, some operational networks, such as electrical power distribution grid & rail communication are now looking to invest the future by deploying 5G services, however their operational channel BW is lower than 5 MHz. Based on this, NR has started the specification work to support channel BW lower than 5 MHz. There are some issues to be resolved.

### SUMMARY

The present disclosure relates to methods, apparatuses, and systems that support control resource set transmission.

Some implementations of the method and apparatuses described herein may include, receiving, via the transceiver, a configuration of a first control resource set (CORESET); determining a second CORESET based on the configuration and a predefined number of physical resource blocks (PRBs) to be punctured from the first CORESET; and determining, based on the configuration, a mapping type of control resource element (CCE) to resource element group (REG) mapping for the second CORESET, a terminal device may experience eased implementation effort. Therefore, the performance of communication is improved.

In some implementations of the method and apparatuses described herein, the configuration may comprise a PRB offset indicative of one of the following: a first frequency gap between a unpunctured synchronization signal block (SSB) and the first CORESET; or a second frequency gap between a punctured SSB and the first CORESET.

Some implementations of the method and apparatuses described herein may further include determining a frequency position of the second CORESET, based on the PRB offset, the predefined number of PRBs to be punctured from the first CORESET, and a frequency position of the unpunctured SSB.

In some implementations of the method and apparatuses described herein, the PRB offset may be selected from a set of candidate PRB offsets, and the set of candidate PRB offsets may be determined based on the predefined number of PRBs to be punctured from the first CORESET.

In some implementations of the method and apparatuses described herein, the predefined number of PRBs to be punctured from the first CORESET in the case that the first CORESET comprises 2 symbols may be the same as or different from the predefined number of PRBs to be punctured from the first CORESET in the case that the first CORESET comprises 3 symbols.

In some implementations of the method and apparatuses described herein, determining the second CORESET may comprise one of the following: puncturing lowest 2 CCEs or lowest 6 PRBs of the first CORESET in the case that the first CORESET comprises 2 symbols; or puncturing the lowest 2 CCEs or lowest 4 PRBs of the first CORESET in the case that the first CORESET comprises 3 symbols.

In some implementations of the method and apparatuses described herein, determining the mapping type may comprise: determining the mapping type as interleaved CCE to REG mapping or non-interleaved CCE to REG mapping based on the number of symbols of the first CORESET.

In some implementations of the method and apparatuses described herein, determining the mapping type based on the number of symbols may comprise one of the following: determining the mapping type as the interleaved CCE to REG mapping in the case that the number of symbols is 2; or determining the mapping type as the non-interleaved CCE to REG mapping in the case that the number of symbols is 3.

Some implementations of the method and apparatuses described herein may further include determining, based on the configuration, a shift value for the CCE-to-REG mapping for the second CORESET.

In some implementations of the method and apparatuses described herein, determining the shift value may comprise: determining the shift value based on the mapping type or the number of symbols of the first CORESET.

In some implementations of the method and apparatuses described herein, determining the shift value based on the mapping type may comprise one of the following: determining the shift value as an identifier (ID) of a cell in which the configuration of the first CORESET is received in the case that the mapping type is interleaved CCE to REG mapping; or determining the shift value as a predetermined value in the case that the mapping type is non-interleaved CCE to REG mapping.

In some implementations of the method and apparatuses described herein, determining the shift value based on the number of symbols may comprise one of the following: determining the shift value as an ID of a cell in which the configuration of the first CORESET is received in the case that the number of symbols is 2; or determining the shift value as a predetermined value in the case that the number of symbols is 3.

In a second aspect of the solution, by transmitting, via the transceiver to a terminal device, a configuration of a first control resource set (CORESET); determining a second CORESET based on the configuration and a predefined number of physical resource blocks (PRBs) to be punctured from the first CORESET; and determining, based on the configuration, a mapping type of control resource element (CCE) to resource element group (REG) mapping for the second CORESET, a network device may experience improved performance of communication.

In some implementations of the method and apparatuses described herein, the configuration may comprise a PRB offset indicative of one of the following: a first frequency gap between a unpunctured synchronization signal block (SSB) and the first CORESET; or a second frequency gap between a punctured SSB and the first CORESET.

Some implementations of the method and apparatuses described herein may further include determining a frequency position of the second CORESET, based on the PRB offset, the predefined number of PRBs to be punctured from the first CORESET, and a frequency position of the unpunctured SSB.

Some implementations of the method and apparatuses described herein may further include determining a set of candidate PRB offsets based on the predefined number of PRBs to be punctured from the first CORESET; and selecting the PRB offset from the set of candidate PRB offsets.

In some implementations of the method and apparatuses described herein, the predefined number of PRBs to be punctured from the first CORESET in the case that the first CORESET comprises 2 symbols may be the same as or different from the predefined number of PRBs to be punctured from the first CORESET in the case that the first CORESET comprises 3 symbols.

In some implementations of the method and apparatuses described herein, determining the second CORESET may comprise one of the following: determining that lowest 2 CCEs or lowest 6 PRBs of the first CORESET are to be punctured in the case that the first CORESET comprises 2 symbols; or determining that the lowest 2 CCEs or lowest 4 PRBs of the first CORESET are to be punctured in the case that the first CORESET comprises 3 symbols.

In some implementations of the method and apparatuses described herein, determining the mapping type may comprise: determining the mapping type as interleaved CCE to REG mapping or non-interleaved CCE to REG mapping based on the number of symbols of the first CORESET.

In some implementations of the method and apparatuses described herein, determining the mapping type based on the number of symbols may comprise one of the following: determining the mapping type as the interleaved CCE to REG mapping in the case that the number of symbols is 2; or determining the mapping type as the non-interleaved CCE to REG mapping in the case that the number of symbols is 3.

Some implementations of the method and apparatuses described herein may further include determining, based on the configuration, a shift value for the CCE-to-REG mapping for the second CORESET.

In some implementations of the method and apparatuses described herein, determining the shift value may comprise: determining the shift value based on the mapping type or the number of symbols of the first CORESET.

In some implementations of the method and apparatuses described herein, determining the shift value based on the mapping type may comprise one of the following: determining the shift value as an identifier (ID) of a cell in which the configuration of the first CORESET is transmitted in the case that the mapping type is interleaved CCE to REG mapping; or determining the shift value as a predetermined value in the case that the mapping type is non-interleaved CCE to REG mapping.

In some implementations of the method and apparatuses described herein, determining the shift value based on the number of symbols may comprise one of the following: determining the shift value as an ID of a cell in which the configuration of the first CORESET is transmitted in the case that the number of symbols is 2; or determining the shift value as a predetermined value in the case that the number of symbols is 3.

### BRIEF DESCRIPTION OF THE DRAWINGS

FIG. 1A illustrates an example of a wireless communications system that supports control resource set transmission in accordance with aspects of the present disclosure.

FIG. 1B illustrates an example of a synchronization signal block (SSB) associated with aspects of the present disclosure.

FIG. 1C illustrates an example multiplexing pattern for SSB and control resource set (CORESET) associated with aspects of the present disclosure.

FIG. 1D illustrates an example mapping method of control resource element (CCE) to resource element group (REG) mapping in the CORESET associated with aspects of the present disclosure.

FIG. 1E illustrates another example mapping method of CCE to REG mapping in the CORESET associated with aspects of the present disclosure.

FIG. 1F illustrates an example CORESET with 4 full CCEs and 2 partial CCEs associated with aspects of the present disclosure.

FIG. 1G illustrates an example CORESET with a set of full CCEs associated with aspects of the present disclosure.

FIG. 2 illustrates an example signaling chart illustrating an example process that supports control resource set transmission in accordance with aspects of the present disclosure.

FIG. 3A illustrates an example multiplexing pattern for SSB and CORESET with 2 symbols that supports control resource set transmission in accordance with aspects of the present disclosure.

FIG. 3B illustrates another example multiplexing pattern for SSB and CORESET with 2 symbols that supports control resource set transmission in accordance with aspects of the present disclosure.

FIG. 3C illustrates another example multiplexing pattern for SSB and CORESET with 2 symbols that supports control resource set transmission in accordance with aspects of the present disclosure.

FIG. 3D illustrates yet another example multiplexing pattern for SSB and CORESET with 2 symbols that supports control resource set transmission in accordance with aspects of the present disclosure.

FIG. 4A illustrates an example multiplexing pattern for SSB and CORESET with 2 symbols that supports control resource set transmission in accordance with aspects of the present disclosure.

FIG. 4B illustrates another example multiplexing pattern for SSB and CORESET with 2 symbols that supports control resource set transmission in accordance with aspects of the present disclosure.

FIG. 4C illustrates another example multiplexing pattern for SSB and CORESET with 2 symbols that supports control resource set transmission in accordance with aspects of the present disclosure.

FIG. 4D illustrates yet another example multiplexing pattern for SSB and CORESET with 2 symbols that supports control resource set transmission in accordance with aspects of the present disclosure.

FIGS. 5 through 6 illustrate examples of devices that support control resource set transmission in accordance with aspects of the present disclosure.

FIGS. 7 through 8 illustrate examples of processors that support control resource set transmission in accordance with aspects of the present disclosure.

FIGS. 9 through 10 illustrate flowcharts of methods that support control resource set transmission in accordance with aspects of the present disclosure.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s). Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

Aspects of the present disclosure are described in the context of a wireless communications system.

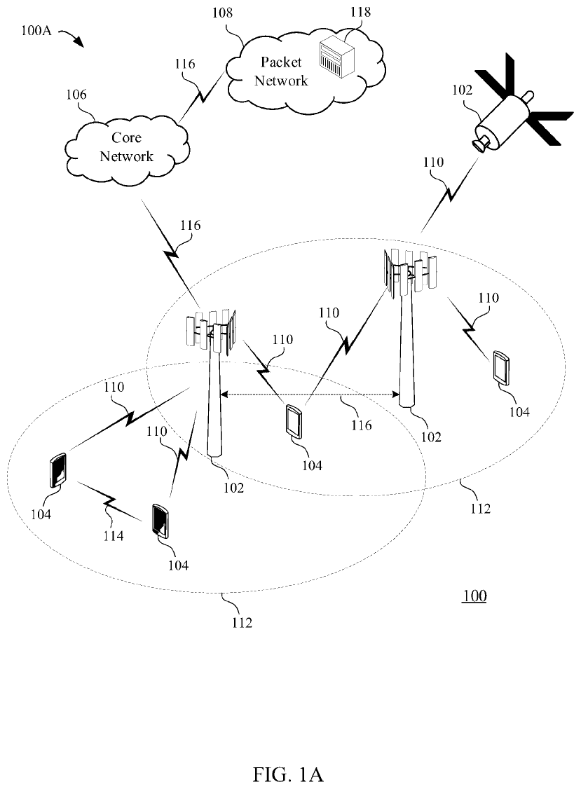

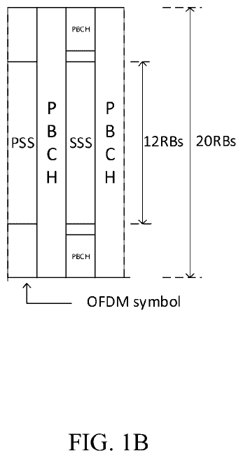

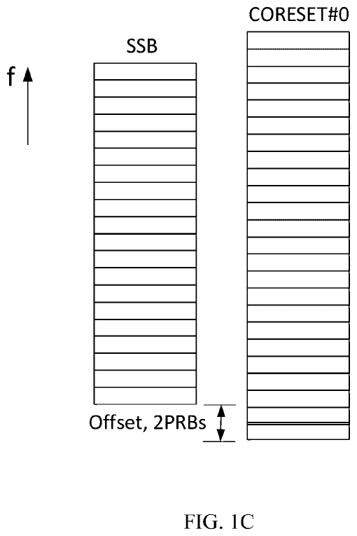

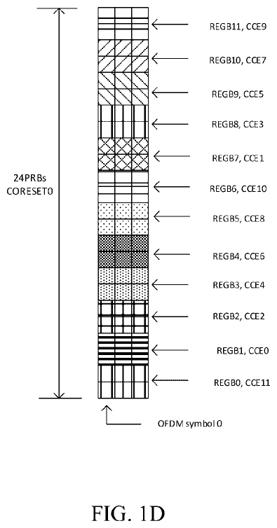

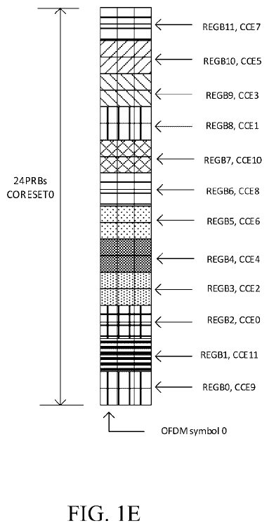

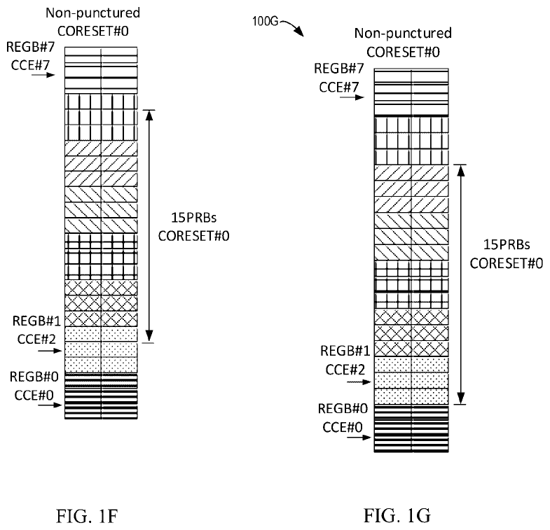

FIG. 1A illustrates an example of a wireless communications system 100 that supports control resource set transmission in accordance with aspects of the present disclosure. The wireless communications system 100 may include one or more network entities 102 (also referred to as network equipment (NE)), one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1A. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1A. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU 160.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. #Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHZ-52.6 GHZ), FR3 (7.125 GHz-24.25 GHZ), FR4 (52.6 GHz-114.25 GHZ), FR4a or FR4-1 (52.6 GHZ-71 GHZ), and FR5 (114.25 GHZ-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

A minimum bandwidth of 5 MHz channels is defined in Release 15. Although NR can support multiple channel bandwidths with flexible numerology, channel bandwidths smaller than 5 MHz are currently not supported. On the other hand, some operational networks, such as electrical power distribution grid & rail communication are now looking to invest the future by deploying 5G services, however their operational channel BW is lower than 5 MHz. Based on this, NR has started the specification work to support channel BW lower than 5 MHz. One objective is to specify a 3 MHz channel BW in some of NR operating bands (e.g., bands n100, n8, n26 and n28).

A 3 MHz channel is correspondingly to 15 physical resource blocks (PRBs). The 15PRBs cannot accommodate some of NR channels or signals. FIG. 1B illustrates an example of a synchronization signal block (SSB) associated with aspects of the present disclosure. NR synchronization signals and physical broadcast channel (SS/PBCH) block (i.e., SSB) occupies 20 resource blocks (RBs) in frequency domain, where primary synchronization signal/secondary synchronization signal (PSS/SSS) occupies 12 RBs (including the guard REs) and the PBCH occupies the whole 20 RBs. As a result, for a channel with 3 MHz BW, the PSS/SSS can be fully transmitted while PBCH cannot be fully transmitted. Some of the SSB resources need to be punctured from both transmission and reception point of view. It is to be understood that the bandwidth of the channel is not limited to 3 MHz, and embodiments of the present disclosure equally apply to other suitable channel bandwidths.

Besides SSB, the legacy CORESET #0 (which is mostly used during initial access for scheduling signals such as System Information Block1 (SIB1), random access messages, etc.) with minimum 24PRBs transmission BW cannot be used for 3 MHz channel BW. The CORESET #0 is configured in PBCH based on a CORESET #0 configuration table. One candidate configuration is chosen from the table and is indicated by a CORESET #0 configuration index. From the indicated configuration index, the UE could obtain a SSB to CORESET #0 multiplexing pattern, the number of CORESET #0 PRBs, the number of CORESET #0 symbols and a PRB offset between the lowest CORESET #0 PRB and the common resource block (CRB) overlapped with the lowest SSB PRB. Table 1 provides CORESET #0 configuration table for 5 MHz minimum channel BW for FR1.

TABLE 1
CORESET#0 configuration table for 5 MHz minimum channel BW

| | SS/PBCH block and | Number | Number of | |
|---|---|---|---|---|
| | CORESET multiplexing | of RBs | Symbols | Offset |
| Index | pattern | N_{RB}^{CORESET} | N_{symb}^{CORESE} | (RBs) |
| 0 | 1 | 24 | 2 | 0 |
| 1 | 1 | 24 | 2 | 2 |
| 2 | 1 | 24 | 2 | 4 |
| 3 | 1 | 24 | 3 | 0 |
| 4 | 1 | 24 | 3 | 2 |
| 5 | 1 | 24 | 3 | 4 |
| 6 | 1 | 48 | 1 | 12 |
| 7 | 1 | 48 | 1 | 16 |
| 8 | 1 | 48 | 2 | 12 |
| 9 | 1 | 48 | 2 | 16 |
| 10 | 1 | 48 | 3 | 12 |
| 11 | 1 | 48 | 3 | 16 |
| 12 | 1 | 96 | 1 | 38 |
| 13 | 1 | 96 | 2 | 38 |
| 14 | 1 | 96 | 3 | 38 |

| | |
|---|---|
| 15 | Reserved |

As specified in NR, the multiplexing of SSB and CORESET #0 for frequency range 1 follows multiplexing pattern 1, where the SSB transmission BW is fully within the CORESET #0 transmission BW. FIG. 1C illustrates an example multiplexing pattern for SSB and control resource set (CORESET) associated with aspects of the present disclosure. As shown in FIG. 1C, the multiplexing pattern for SSB and CORESET #0 is multiplexing pattern 1. The offset between the lowest position of the SSB and lowest position of CORESET #0 in frequency domain is 2PRBs, and this offset is indicated by the CORESET #0 configuration index as shown in table 1. The UE detects the SSB firstly and then could locate the CORESET #0 based on the indicated PRB offset.

From Table 1, it can be observed that even the minimum 24 PRBs (4.32 MHz with 15 kHz SCS) CORESET #0 transmission is larger than 3 MHz channel BW. Therefore, this table cannot be used for 3 MHz channel BW. One way is that the 15PRBs CORESET #0 for 3 MHz channel BW is obtained by puncturing the legacy 24PRBs CORESET #0. The problem of which PRBs of 24PRBs are punctured for 15PRBs CORESET #0 needs to be resolved.

The basic unit for physical downlink control channel (PDCCH) transmission in a CORESET is a CCE. One CCE corresponds to 6 REGs, each of which contains one PRB (12 subcarriers) in frequency domain and 1 symbol in time domain. The REGs are numbered sequentially in time first, frequency second manner in the CORESET. The REGs are further sequentially grouped to be REG bundles. UE could assume same precoding is used for the REGs in the same REG bundle, and joint channel estimation should be performed by the UE in the REGs in the same REG bundle.

One CCE is associated with a REG bundle. As specified, REG bundle i consists of REGs {iL,iL+1, . . . , iL+L−1}, where L is the REG bundle SIZE,

$$i = 0 , 1 , … , {N}_{REG}^{CORESET} / L - 1 , and {N}_{REG}^{CORESET} = {N}_{RB}^{CORESET} {N}_{symb}^{CORESET}$$

is the number of REGs in the CORESET. The CCE to REG mapping for a CORESET could be either interleaved or non-interleaved and is described by REG bundles. Specifically, CCE j consists of REG bundles {f(6j/L), f(6j/L+1), . . . , f(6j/L+6/L−1)} where f(·) is an interleaver and is defined as below:

$$f ( x ) = ( rC + c + {n}_{shift} ) mod ( {N}_{REG}^{CORESET} / L )$$

$$x = cR + r$$

$$r = 0 , 1 , … , R - 1$$

$$c = 0 , 1 , … , C - 1$$

$$C = {N}_{REG}^{CORESET} / ( LR )$$

wherein for CORESET #0, it was specified that

$${N}_{RB}^{CORESET}$$

is the number of PRBs in frequency domain.

$${N}_{symb}^{CORESET}$$

is the number of OFDM symbols in time domain. L equals 6, which means one REG bundle contains 6 REGs, same size as a CCE. R is a interleaver size and equals 2.

$${n}_{shift} = {N}_{ID}^{cell} ,$$

i.e., the identifier (ID) of the cell.

Therefore, with the parameter

$${n}_{shift} = {N}_{ID}^{cell} ,$$

the CCE to REG mapping is different in different cells, which is beneficial to randomize the CCEs contained in a PDCCH candidate among cells thus it could mitigate the inter-cell interference. The first CCE of CORESET #0, CCE0, starts from the REG bundle (REGB)

$$X = {n}_{shift} mod ( {N}_{REG}^{CORESET} / L ) .$$

Supposing the number of REG bundles is K (K is an always even number for COERSET #0), the CCEs in CORESET #0 are numbered as:
CCE 2*i (here the value “2” corresponds to “R” in the formula) maps to REGB X+i, i=0, 1, 2, . . . , K/2−1.
   If X+i>K−1, then CCE numbering is continued in a wraparound way from REGB0;
CCE 2*i+1 (similarly, the value “2” corresponds to “R” in the formula) maps to REGB X+i+K/2, i=0, 1, 2, . . . , K/2−1.
   If X+i+K/2>K−1, then CCE numbering is continued in a wraparound way from REGB0.

FIG. 1D and FIG. 1E illustrates two example mapping method of CCE to REG mapping in the CORESET associated with aspects of the present disclosure. FIG. 1D and FIG. 1E show how CCE-to-REG is mapped in the CORESET #0 with 24PRB, 3symbol, and CORESET #0 consists of 12 REGBs. In FIG. 1D, n_{shift}=1, and CCE0 maps to REGB1, while in FIG. 1E, CCE0 maps to REGB 2 with n_{shift}=2.

The PDCCH is transmitted in a set of CCEs of a CORESET. The number of CCEs for PDCCH transmission is named also as a specific aggregation level. One or multiple PDCCH candidates are supported by an aggregation level n, each contains n CCEs. For PDCCH in CORESET #0, the supported aggregation levels and the maximum number of PDCCH candidates per aggregation level were specified as in below table 2.

TABLE 2
CCE aggregation levels for CORESET#0

| CCE Aggregation Level | Number of Candidates |
|---|---|
| 4 | 4 |
| 8 | 2 |
| 16 | 1 |

The CCEs for a candidate of an aggregation level (AL) is determined by a hash function. Table 3a and 3b show the CCEs in each candidate of each aggregation level for CORESET #0 with 2symbol and 3symbol respectively.

TABLE 3a
PDCCH candidates for (24PRBs, 2symbols) CORESET#0

| AL | 1st candidate | 2nd candidate | 3rd candidate | 4th candidate |
|---|---|---|---|---|
| 4 | 0, 1, 2, 3 | 4, 5, 6, 7 | — | — |
| 8 | 0, 1, 2, 3, 4, 5, 6, 7 | — | — | — |
| 16 | — | — | — | — |

TABLE 3b
PDCCH candidates for (24PRBs, 3symbols) CORESET#0

| AL | 1st candidate | 2nd candidate | 3rd candidate | 4th candidate |
|---|---|---|---|---|
| 4 | 0, 1, 2, 3 | 4, 5, 6, 7 | 8, 9, 10, 11 | — |
| 8 | 0, 1, 2, 3, 4, 5, 6, 7 | — | — | — |
| 16 | — | — | — | — |

For PBCH and CORESET #0 for 3 MHz channel BW, the PBCH transmission bandwidth is 12 PRBs. The upper 4PRBs and lower 4PRBs of 20PRB NR PBCH are punctured. The maximum number of CORESET #0 symbols is 3. The minimum number of CORESET #0 symbols is 2. SSB and CORESET #0 multiplexing pattern 1 is used. REG bundle size=6.

Both 12 PRBs CORESET #0 and 15 PRBs CORESET #0 are supported. In case of 12 PRBs, the legacy interleaved (R=2) CORESET CCE-to-REG mapping is used with

$${N}_{RB}^{CORESET} = 12 ,$$

i.e., 12PRBs are indicated without puncturing.

In case of 15 PRBs, the

$${N}_{RB}^{CORESET} = 24 ,$$

CORESET #0 is punctured from 24PRBs legacy CORESET #0 for 5 MHz channel BW. Both interleaved (legacy interleaver size of R=2) and non-interleaved mapping are supported. Some entries in a configuration table for 3 MHz channel BW for CORESET #0 are related with interleaved mapping and some are non-interleaved mapping. A single table of up to 16 entries to accommodate both cases.

Therefore, when PRBs of 24PRBs are punctured for 15PRBs CORESET #0, it is expected that the 15PRBs CORESET #0 contains a set of full CCEs of the legacy CORESET #0 since channel estimation of is per-CCE conducted. FIG. 1F illustrates an example of 15PRBs CORESET #0 with 4 full CCEs and 2 partial CCEs associated with aspects of the present disclosure, which is not desired. FIG. 1G illustrates an example of 15PRBs CORESET #0 with a set of full CCEs associated with aspects of the present disclosure.

In addition, for PRB offset, one option is that it indicates the frequency gap between the unpunctured SSB and unpunctured CORESET #0. Besides, it is expected that same PDCCH detection performance could be achieved among cells which requires that the maximum number of available CCEs for an AL is the same among cells. With these requirement, the problems of how to locate the 15PRBs CORESET #0 in frequency domain, which entries are corresponding to interleaved and which are corresponding to non-interleaved in the CORESET #0 configuration table, how the CCE to REG mapping is performed for 15PRBs CORESET #0 need to be resolved. It is to be understand that the CORESET #0 is only for the purpose of illustration without suggesting any limitations, and embodiments of the present disclosure equally apply to other similar control resource sets.

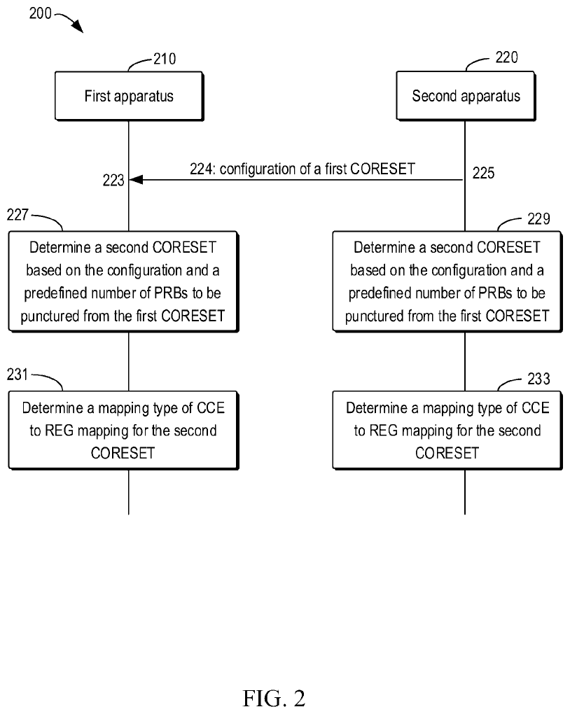

In view of the above discussions, embodiments of the present disclosure provide a solution for control resource set transmission. In one aspect of the solution of the present disclosure, a terminal device receives a configuration of a first CORESET via the transceiver. Based on the configuration and a predefined number of PRBs to be punctured from the first CORESET, the terminal device determines a second CORESET. Based on the configuration, the terminal device determines a mapping type of CCE to REG mapping for the second CORESET. In this way, the CORESET may be punctured into a CORESET with less PRBs in a suitable method for a transmission in narrow bandwidth channels. A mapping type of CCE to REG mapping may be determine for PDDCH transmission. Therefore, the terminal device side implementation effort is eased and the performance of communication is improved. Principles and implementations of embodiments of the present disclosure will be described in detail below with reference to FIGS. 2-10.

FIG. 2 illustrates an example signaling chart illustrating an example process 200 that supports control resource set transmission in accordance with aspects of the present disclosure. The process 200 may involve a first apparatus 210 and a second apparatus 220. The first apparatus 210 may be an example of the UE 104 in FIG. 1A, the second apparatus 220 may be a network entity 102 in FIG. 1A.

In the example process 200, the first apparatus 210 receives 203 a configuration 204 of a first CORESET via the transceiver. Correspondingly, the second apparatus 220 transmits 205 the configuration of a first CORESET 204 to the first apparatus 210. For example, the first CORESET may be a unpunctured CORESET #0 with 24 PRBs.

In some embodiments, the configuration 204 may comprise a PRB offset. The PRB offset may indicate a first frequency gap between a unpunctured SSB and the first CORESET. In some embodiments, the PRB offset may indicate a second frequency gap between a punctured SSB and the first CORESET.

Based on the configuration 204 and a predefined number of PRBs to be punctured from the first CORESET, the first apparatus 210 determines 207 a second CORESET. Based on the configuration and a predefined number of PRBs to be punctured from the first CORESET, the second apparatus 220 determines 207 a second CORESET. For example, the second CORESET may be punctured CORESET #0 with 15 PRBs. In other words, the first apparatus 210 and the second apparatus 220 determines which PRBs of the unpunctured CORESET #0 to be punctured.

In some embodiments, the predefined number of PRBs to be punctured from the first CORESET in the case that the first CORESET comprises 2 symbols is the same as or different from the predefined number of PRBs to be punctured from the first CORESET in the case that the first CORESET comprises 3 symbols. In an example, the number of symbols of the first CORESET is indicated by the configuration 204.

In some embodiments, the configuration 204 may comprise an indication of the number of OFDM symbols. In order to determine the second CORESET, the first apparatus 210 may puncture lowest 2 CCEs or lowest 6 PRBs of the first CORESET in the case that the first CORESET comprises 2 symbols. In some embodiments, in order to determine the second CORESET, the first apparatus 210 may puncture the lowest 2 CCEs or lowest 4 PRBs of the first CORESET in the case that the first CORESET comprises 3 symbols.

In some embodiments, in order to determine the second CORESET, the second apparatus 220 may puncture lowest 2 CCEs or lowest 6 PRBs of the first CORESET in the case that the first CORESET comprises 2 symbols. In some embodiments, in order to determine the second CORESET, the second apparatus 220 may puncture the lowest 2 CCEs or lowest 4 PRBs of the first CORESET in the case that the first CORESET comprises 3 symbols.

In an example, a single PRB level puncturing pattern is defined, and the predefined number of PRBs to be punctured from the first CORESET is defined for both CORESET #0 with 2symbols and CORESET #0 with 3symbols. To guarantee the punctured CORESET #0 (i.e., 15PRBs) containing a full set of CCEs, the number of punctured PRBs in lower frequency region should be multiple of 6, so that integer number of CCEs are punctured for 2 symbols (3 punctured CCEs) or 3 symbols (2 punctured CCEs) and the 15PRBs CORESET #0 starts from the lowest position of a specific CCE and contains a set of full CCEs. Furthermore, if multiplexing pattern 1 should be maintained between unpunctured SSB and unpunctured CORESET #0, then puncturing 6PRBs is a solution that may meet these requirements.

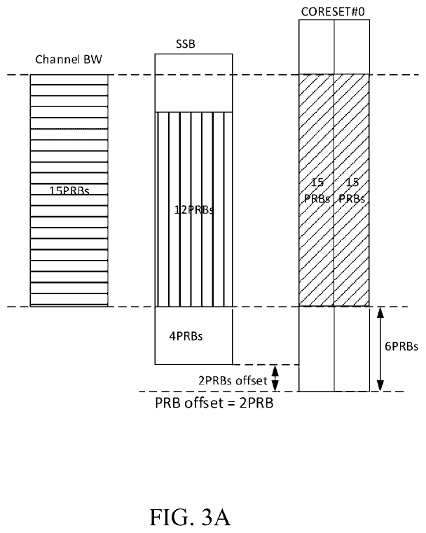

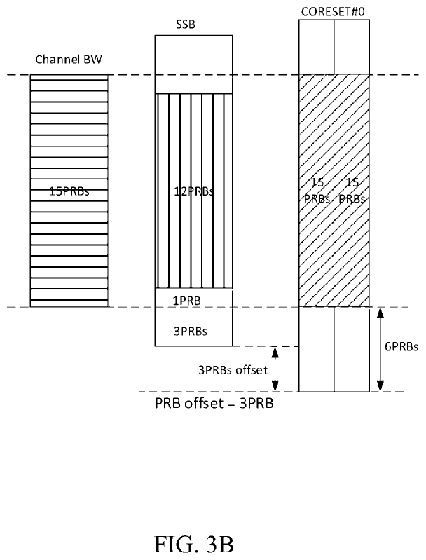

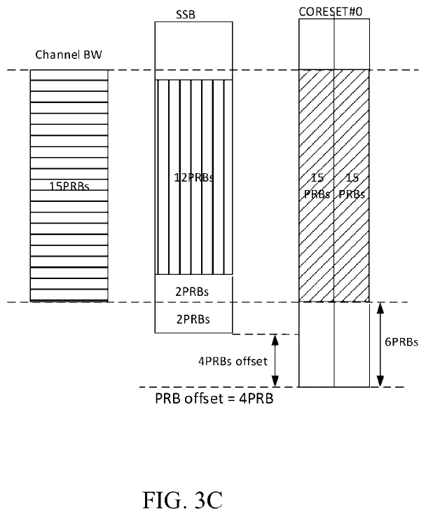

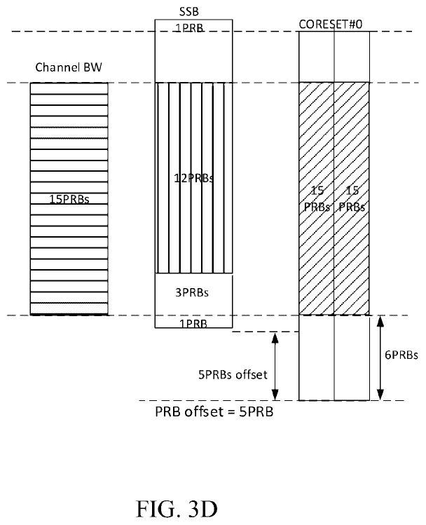

However, puncturing 6PRBs cannot support fully flexible locations of the punctured SSB within the 15PRBs channel BW. FIGS. 3A-3D show the candidate locations of the 12PRBs punctured SSB within the channel BW, where 0, 1, 2 and 3 PRBs of the offset between the lowest position of punctured SSB to the lowest position of the channel BW are shown, respectively. 6PRBs are punctured from the lowest part of CORESET #0. From the figures, it could be observed that in FIGS. 3A-3C, multiplexing pattern 1 between unpunctured SSB and unpunctured CORESET #0 could be maintained. However, in FIGS. 3D, the unpunctured SSB is not fully within the BW of the unpunctured CORESET #0 thus multiplexing pattern 1 cannot be maintained.

To keep the multiplexing pattern 1 between unpunctured SSB and unpunctured CORESET #0 while supporting the flexible location of punctured SSB within the channel BW, it is proposed that for both 2symbols CORESET #0 and 3symbols CORESET #0, the first apparatus 210 assumes that same number of CCEs in the lowest part of 24PRBs CORESET #0 is punctured. As one embodiment, for both 2symbols CORESET #0 with 15PRBs and 3symbols CORESET #0 with 15PRBs, the lowest 2CCEs are punctured, which corresponding to 6PRBs of 2symbols unpunctured CORESET #0 and 4PRBs of 3symbols unpunctured CORESET #0 are punctured.

In some embodiments, the first apparatus 210 may determine a frequency position of the second CORESET based on the PRB offset, the predefined number of PRBs to be punctured from the first CORESET, and a frequency position of the unpunctured SSB.

In some embodiments, the second apparatus 220 may determine a frequency position of the second CORESET based on the PRB offset, the predefined number of PRBs to be punctured from the first CORESET, and a frequency position of the unpunctured SSB.

In an example, to determine the location of 15PRB CORESET #0, the first apparatus 210 may be indicated with a PRB offset. The PRB offset may be the frequency gap between the lowest PRB of unpunctured SSB and the lowest PRB of the unpunctured CORESET #0 in frequency domain. Based on the indicated PRB offset and the punctured PRBs, the first apparatus 210 could get the location of the punctured CORESET #0 using the following steps:

Based on the received PSS/SSS and based on the agreed puncturing pattern for PBCH (upper 4 PRBs and lower 4PRBs are punctured), the first apparatus 210 could determine the location of the unpunctured 20PRB SSB. Based on the location of the unpunctured SSB and the indicated PRB offset, the first apparatus 210 could determine the location of the unpunctured 24PRBs CORESET #0. Based on the location of the unpunctured CORESET #0 and the predefined punctured PRBs for CORESET #0, the first apparatus 210 could determine the location of the 15PRBs CORESET #0.

In some embodiments, the second apparatus 220 may determine a set of candidate PRB offsets based on the predefined number of PRBs to be punctured from the first CORESET. Then the second apparatus 220 may select the PRB offset from the set of candidate PRB offsets.

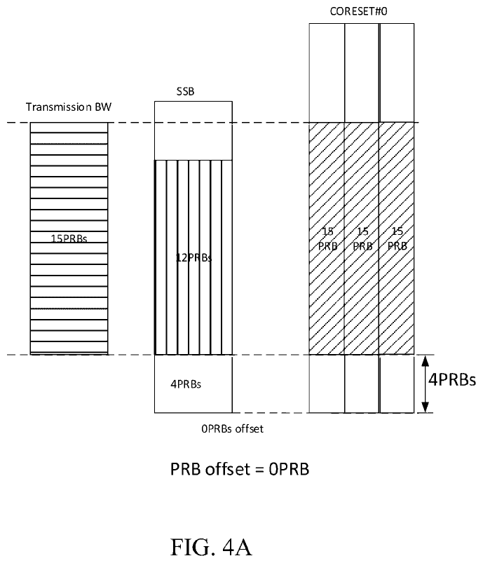

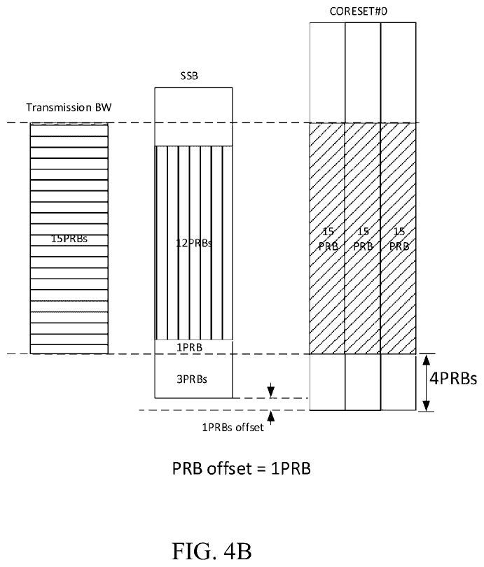

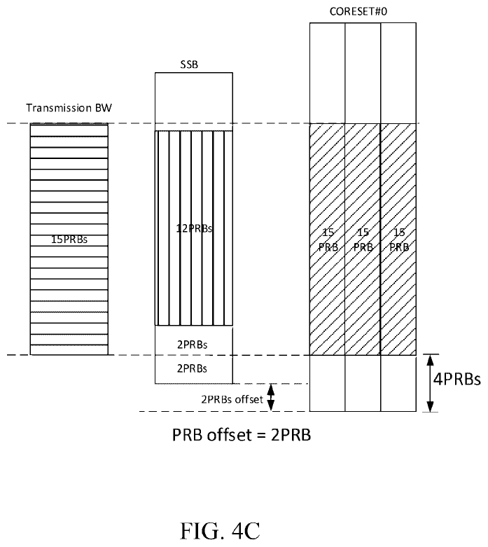

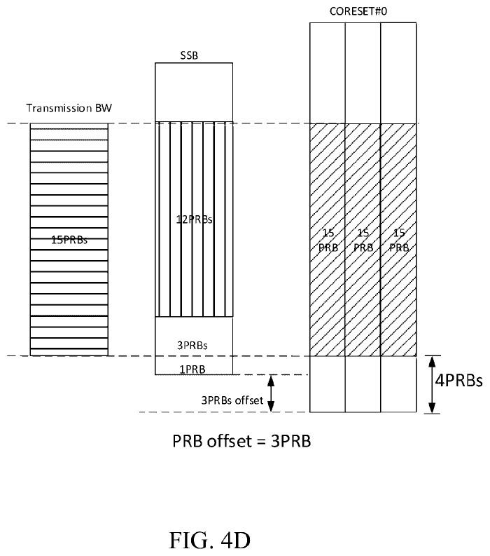

In an example, for 2symbols CORESET #0, it still cannot support full flexible locations of PBCH as shown in FIGS. 3A-3D. For 3symbols CORESET #0 with 4PRBs being punctured, full flexibility of PBCH location can be achieved. FIGS. 4A-4D illustrate full flexible PBCH location with 2CCEs (4PRBs) punctured for 3symbols CORESET #0. Therefore, for 2symbols CORESET #0, 3 positions among the 4 candidate positions of PBCH are supported, while for 3symbols CORESET #0, all the 4 candidate PBCH positions are supported. The second apparatus 220 can configure 3symbols CORESET #0 if the PBCH is located in a position that 2symbols CORESET #0 does not support.

The candidate PRB offsets for CORESET #0 determination depends on the relative position of the SSB and the channel BW. Specifically, the PRB offset is equal to the number of punctured CORESET #0 PRBs minus the number of punctured PBCH PRBs and a frequency offset between the punctured SSB and the channel BW. For 2symbols CORESET #0 with 6 punctured PRBs, the supported PRB offsets are {2, 3, 4} PRBs, as shown in FIGS. 3A-3C. For 3symbols CORESET #0 with 4 punctured PRBs, the supported PRB offsets are {0, 1, 2, 3} PRBs, as shown in FIGS. 4A-4D.

Based on the configuration, the first apparatus 210 determines 209 a mapping type of CCE to REG mapping for the second CORESET. In some embodiments, in order to determine the mapping type, the first apparatus 210 may determine the mapping type as interleaved CCE to REG mapping or non-interleaved CCE to REG mapping based on the number of symbols of the first CORESET. In an example, the number of symbols of the first CORESET is indicated by the configuration 204.

In some embodiments, in order to determine the mapping type based on the number of symbols, the first apparatus 210 may determine the mapping type as the interleaved CCE to REG mapping in the case that the number of symbols is 2. In some embodiments, in order to determine the mapping type based on the number of symbols, the first apparatus 210 may determine the mapping type as the non-interleaved CCE to REG mapping in the case that the number of symbols is 3.

In some embodiments, based on the configuration, the first apparatus 210 may determine a shift value for the CCE-to-REG mapping for the second CORESET. In some embodiments, in order to determine the shift value, the first apparatus 210 may determine the shift value based on the mapping type or the number of symbols of the first CORESET.

In some embodiments, in order to determine the shift value based on the mapping type, the first apparatus 210 may determine the shift value as an ID of a cell in which the configuration of the first CORESET is received in the case that the mapping type is interleaved CCE to REG mapping. In some embodiments, in order to determine the shift value based on the mapping type, the first apparatus 210 may determine the shift value as a predetermined value in the case that the mapping type is non-interleaved CCE to REG mapping.

In some embodiments, in order to determine the shift value based on the number of symbols, the first apparatus 210 may determine the shift value as an ID of a cell in which the configuration of the first CORESET is received in the case that the number of symbols is 2. In some embodiments, in order to determine the shift value based on the number of symbols, the first apparatus 210 may determine the shift value as a predetermined value in the case that the number of symbols is 3.

In an example, which entries of CORESET #0 configuration table are for interleaved CCE to REG mapping and which are for non-interleaved CCE to REG mapping is determined. It is assumed that same number of CCEs are punctured for both 2symbols and 3symbols CORESET #0. However, it is also applicable for the case that same number of PRBs are punctured for the two sizes CORESET #0.

For 2symbols CORESET #0, by reusing equation of CCE to REG mapping and the hash function of determination of CCEs in each PDCCH candidate, those CCEs that are contained in the 15PRB CORESET and also the CCEs for each PDCCH candidate for non-interleaved CCE to REG mapping and interleaved CCE to REG mapping is obtained as below.

Table 4 is for non-interleaved CCE to REG mapping, and it shows the CCEs contained in the 2symbols CORESET #0 and the CCEs for each PDCCH candidate of AL is equal to 4 and 8 for different n_shift values.

Table 5 is for interleaved CCE to REG mapping, and it shows the CCEs contained in the 2symbols CORESET #0 and the CCEs for each PDCCH candidate of AL is equal to 4 and 8 for different n_shift values.

TABLE 4
Non-interleaved CCE to REG mapping for 2symbols CORESET#0

| | CCEs contained in | | |
|---|---|---|---|
| N_shift | the punctured | AL = 4 | AL = 8 |
| mod 8 | CORESET#0 | candidates | candidate |
| 0 | {2, 3, 4, 5, 6} | {2, 3}, {4, 5, 6} | {2, 3, 4, 5, 6} |
| 1 | {1, 2, 3, 4, 5} | {1, 2, 3}, {4, 5} | {1, 2, 3, 4, 5} |
| 2 | {0, 1, 2, 3, 4} | {0, 1, 2, 3}, {4} | {0, 1, 2, 3, 4} |
| 3 | {7, 0, 1, 2, 3} | {0, 1, 2, 3}, {7} | {7, 0, 1, 2, 3} |
| 4 | {6, 7, 0, 1, 2} | {0, 1, 2}, {6, 7} | {6, 7, 0, 1, 2} |
| 5 | {5, 6, 7, 0, 1} | {5, 6, 7}, {0, 1} | {5, 6, 7, 0, 1} |
| 6 | {4, 5, 6, 7, 0} | {0}, {4, 5, 6, 7} | {4, 5, 6, 7, 0} |
| 7 | {3, 4, 5, 6, 7} | {3}, {4, 5, 6, 7} | {3, 4, 5, 6, 7} |

TABLE 5
Interleaved CCE to REG mapping for 2symbols CORESET#0

| | CCEs contained in | | |
|---|---|---|---|
| N_shift | the punctured | AL = 4 | AL = 8 |
| mod 8 | CORESET#0 | candidates | candidate |
| 0 | {4, 6, 1, 3, 5} | {4, 5, 6}, {1, 3} | {4, 6, 1, 3, 5} |
| 1 | {2, 4, 6, 1, 3} | {1, 2, 3}, {4, 6} | {2, 4, 6, 1, 3} |
| 2 | {0, 2, 4, 6, 1} | {0, 1, 2}, {4, 6} | {0, 2, 4, 6, 1} |
| 3 | {7, 0, 2, 4, 6} | {4, 6, 7}, {0, 2} | {7, 0, 2, 4, 6} |
| 4 | {5, 7, 0, 2, 4} | {4, 5, 7}, {0, 2} | {5, 7, 0, 2, 4} |
| 5 | {3, 5, 7, 0, 2} | {0, 2, 3}, {5, 7} | {3, 5, 7, 0, 2} |
| 6 | {1, 3, 5, 7, 0} | {0, 1, 3}, {5, 7} | {1, 3, 5, 7, 0} |
| 7 | {6, 1, 3, 5, 7} | {5, 6, 7}, {1, 3} | {6, 1, 3, 5, 7} |

From Table 4 (non-interleaved CCE to REG mapping), it can be observed that for different n_shift values, which corresponds to different cell IDs, the number of available CCEs in an AL=4 PDCCH candidate might be different. If unified PDCCH detection among cells and full AL=4 PDCCH candidate is required, then only the entries N_shift mod 8=2/3/6/7 could be used. This requires that n_shift should be revised from simply being cell ID to be in a form like x=mod (cell ID, 4), and n_shift (x)=2/3/6/7 for x=0/1/2/3.

From Table 5 (interleaved CCE to REG mapping), it can be observed that the number of available CCEs of each PDCCH candidate is same for all n_shift values, leading to unified PDCCH detection performance among cells. However, there are up to 3 CCEs are available for AL is equal to 4 candidates. The supported actual aggregation levels are AL is equal to 3 and 5 in this case.

From the tables, it could be observed that AL is equal to 4 and 5 are supported for non-interleaved CCE to REG mapping while AL is equal to 3 and 5 are supported for interleaved CCE to REG mapping. Considering that finer link adaptation for PDCCH is almost meaningless especially for UEs during initial access (e.g., in legacy CORESET #0, AL is equal to 4, 8 and 16 are specified), also considering the standard impact of using non-interleaved CCE to REG mapping as explained for table 4, it is proposed that for 2 symbols punctured CORESET #0, only interleaved CCE to REG mapping is supported and n_shift in the CCE to REG mapping is equal to cell ID. The CCE to REG mapping and the hash function for determination of CCEs in each PDCCH candidate can fully follow the defined equations.

For 3symbols CORESET #0, we could get those CCEs that are contained in the 15PRB CORESET and also the CCEs for each PDCCH candidate for non-interleaved CCE to REG mapping and interleaved CCE to REG mapping as below.

Table 6 is for non-interleaved CCE to REG mapping, and it summarizes the CCEs contained in the 3symbols CORESET #0 and the CCEs for each candidate of AL is equal to 4 and 8 for different n_shift value.

Table 7 is for interleaved CCE to REG mapping, and it summarizes the CCE contained in the 3symbols CORESET #0 and the CCEs for each candidate of AL is equal to 4 and 8 for different n_shift value.

TABLE 6
Non-interleaved CCE to REG mapping for 3symbols CORESET#0

| | CCEs contained in | | |
|---|---|---|---|
| N_shift | the punctured | AL = 4 | AL = 8 |
| mod 12 | CORESET#0 | candidates | candidates |
| 0 | {2, 3, 4, 5, 6, 7, 8, 9} | {2, 3}, {4, 5, 6, 7}, {8, 9} | {2, 3, 4, 5, 6, 7} |
| 1 | {1, 2, 3, 4, 5, 6, 7, 8} | {1, 2, 3}, {4, 5, 6, 7}, {8} | {1, 2, 3, 4, 5, 6, 7} |
| 2 | {0, 1, 2, 3, 4, 5, 6, 7} | {0, 1, 2, 3}, {4, 5, 6, 7} | {0, 1, 2, 3, 4, 5, 6, 7} |
| 3 | {11, 0, 1, 2, 3, 4, 5, 6} | {0, 1, 2, 3}, {4, 5, 6}, {11} | {0, 1, 2, 3, 4, 5, 6} |
| 4 | {10, 11, 0, 1, 2, 3, 4, 5} | {0, 1, 2, 3}, {4, 5}, {10, 11} | {0, 1, 2, 3, 4, 5} |
| 5 | {9, 10, 11, 0, 1, 2, 3, 4} | {0, 1, 2, 3}, {4}, {9, 10, 11} | {0, 1, 2, 3, 4} |
| 6 | {8, 9, 10, 11, 0, 1, 2, 3} | {0, 1, 2, 3}, {8, 9, 10, 11} | {0, 1, 2, 3} |
| 7 | {7, 8, 9, 10, 11, 0, 1, 2} | {0, 1, 2}, {7}, {8, 9, 10, 11} | {0, 1, 2, 7} |
| 8 | {6, 7, 8, 9, 10, 11, 0, 1} | {0, 1}, {6, 7}, {8, 9, 10, 11} | {0, 1, 6, 7} |
| 9 | {5, 6, 7, 8, 9, 10, 11, 0} | {0}, {5, 6, 7}, {8, 9, 10, 11} | {0, 5, 6, 7} |
| 10 | {4, 5, 6, 7, 8, 9, 10, 11} | {4, 5, 6, 7}, {8, 9, 10, 11} | {4, 5, 6, 7} |
| 11 | {3, 4, 5, 6, 7, 8, 9, 10} | {3}, {4, 5, 6, 7}, {8, 9, 10} | {3, 4, 5, 6, 7} |

TABLE 7
Interleaved CCE to REG mapping for 3symbols CORESET#0

| | CCEs contained in | | |
|---|---|---|---|
| N_shift | the punctured | AL = 4 | AL = 8 |
| mod 12 | CORESET#0 | candidates | candidates |
| 0 | {4, 6, 8, 10, 1, 3, 5, 7} | {1, 3}, {4, 5, 6, 7}, {8, 10} | {1, 3, 4, 5, 6, 7} |
| 1 | {2, 4, 6, 8, 10, 1, 3, 5} | {1, 2, 3}, {4, 5, 6}, {8, 10} | {1, 2, 3, 4, 5, 6} |
| 2 | {0, 2, 4, 6, 8, 10, 1, 3} | {0, 1, 2, 3}, {4, 6}, {8, 10} | {0, 1, 2, 3, 4, 6} |
| 3 | {11, 0, 2, 4, 6, 8, 10, 1} | {0, 1, 2}, {4, 6}, {8, 10, 11} | {0, 1, 2, 4, 6} |
| 4 | {9, 11, 0, 2, 4, 6, 8, 10} | {0, 2}, {4, 6}, {8, 9, 10, 11} | {0, 2, 4, 6} |
| 5 | {7, 9, 11, 0, 2, 4, 6, 8} | {0, 2}, {4, 6, 7}, {8, 9, 11} | {0, 2, 4, 6, 7} |
| 6 | {5, 7, 9, 11, 0, 2, 4, 6} | {0, 2}, {4, 5, 6, 7}, {9, 11} | {0, 2, 4, 5, 6, 7} |
| 7 | {3, 5, 7, 9, 11, 0, 2, 4} | {0, 2, 3}, {4, 5, 7}, {9, 11} | {0, 2, 3, 4, 5, 7} |
| 8 | {1, 3, 5, 7, 9, 11, 0, 2} | {0, 1, 2, 3}, {5, 7}, {9, 11} | {0, 1, 2, 3, 5, 7} |
| 9 | {10, 1, 3, 5, 7, 9, 11, 0} | {0, 1, 3}, {5, 7}, {9, 10, 11} | {0, 1, 3, 5, 7} |
| 10 | {8, 10, 1, 3, 5, 7, 9, 11} | {1, 3}, {5, 7}, {8, 9, 10, 11} | {1, 3, 5, 7} |
| 11 | {6, 8, 10, 1, 3, 5, 7, 9} | {1, 3}, {5, 6, 7}, {8, 9, 10} | {1, 3, 5, 6, 7} |

From Table 6 (non-interleaved CCE to REG mapping), it can be observed that for different n_shift values, which corresponds to different cell IDs, the number of available CCEs in an AL is equal to 4 and 8 PDCCH candidate might be different. If we target to have unified PDCCH detection among cells and to have full AL is equal to 4 PDCCH candidate, meanwhile to have a full AL=8 candidate, then only the entry of N_shift mod 12=2 in table 6 could be used. This requires that the n_shift value should be revised from being cell ID (as in legacy) to be simply n_shift=2 for all cells.

From Table 7 (interleaved CCE to REG mapping), it can be observed that for different n_shift values, which corresponds to different cell ID, the number of available CCEs in an AL is equal to 4 and 8 PDCCH candidate might be different. If we target to have unified PDCCH detection among cells and to have full AL=4 PDCCH candidate, then only the one entry marked with blue could be used. This requires that the n_shift value should be revised from simply being cell ID (as in legacy) to be in a form like x=mod (cell ID, 4), and n_shift (x)=0/2/6/8 for x=0/1/2/3.

From the tables, it could be observed that AL is equal to 4 and 8 are supported for non-interleaved CCE to REG mapping while AL is equal to 4 and 6 are supported for interleaved CCE to REG mapping. The non-interleaved CCE to REG mapping supports max.8 AL and two AL=4 candidates while the interleaved CCE to REG mapping supports max.6 AL and only 1 AL-4 candidate. Based on this and based on similar considerations for 2symbols CORESET #0, it is proposed that for 3symbols punctured CORESET #0, only non-interleaved CCE to REG mapping is supported and n_shift in the CCE to REG mapping is equal to a specific value 2. The hash function for determination of CCEs in each PDCCH candidate can fully follow the defined equation.

Therefore, it is proposed that n_shift is differently defined for 2symbols CORESET #0 and 3symbols CORESET #0. For 15PRBs and 2symbols CORESET #0, n_shift is equal to cell ID and interleaved CCE to REG mapping is selected. For 15PRBs and 3symbols CORESET #0, n_shift is equal to a specific value (e.g., 2) and non-interleaved CCE to REG mapping is selected.

Based on the configuration, the second apparatus 220 determines 209 a mapping type of CCE to REG mapping for the second CORESET. In some embodiments, in order to determine the mapping type, the second apparatus 220 may determine the mapping type as interleaved CCE to REG mapping or non-interleaved CCE to REG mapping based on the number of symbols of the first CORESET.

In some embodiments, in order to determine the mapping type based on the number of symbols, the second apparatus 220 may determine the mapping type as the interleaved CCE to REG mapping in the case that the number of symbols is 2. In some embodiments, in order to determine the mapping type based on the number of symbols, the first apparatus 210 may determine the mapping type as the non-interleaved CCE to REG mapping in the case that the number of symbols is 3.

In some embodiments, based on the configuration, the second apparatus 220 may determine a shift value for the CCE-to-REG mapping for the second CORESET. In some embodiments, in order to determine the shift value, the second apparatus 220 may determine the shift value based on the mapping type or the number of symbols of the first CORESET.

In some embodiments, in order to determine the shift value based on the mapping type, the second apparatus 220 may determine the shift value as an ID of a cell in which the configuration of the first CORESET is received in the case that the mapping type is interleaved CCE to REG mapping. In some embodiments, in order to determine the shift value based on the mapping type, the second apparatus 220 may determine the shift value as a predetermined value in the case that the mapping type is non-interleaved CCE to REG mapping.

In some embodiments, in order to determine the shift value based on the number of symbols, the second apparatus 220 may determine the shift value as an ID of a cell in which the configuration of the first CORESET is received in the case that the number of symbols is 2. In some embodiments, in order to determine the shift value based on the number of symbols, the second apparatus 220 may determine the shift value as a predetermined value in the case that the number of symbols is 3.

In summary, a same set of CCEs or REG bundles is punctured from the lower part of frequency region for both 2symbols CORESET #0 and 3symbols CORESET #0. For example, 2CCEs are punctured for both 2symbols and 3symbols CORESET #0, which corresponds to 6PRBs and 4PRBs being punctured respectively. Separate set of PRB offsets for 2symbols and 3symbols CORESET #0 is defined based on the number of punctured PRBs to support flexible locations of punctured SSB within the channel BW. the locations of 15PRBs CORESET #0 is determined based on the indicated PRB offset and the number of punctured PRBs. For punctured 15PRB CORESET #0, n_shift is different for interleaved and non-interleaved CCE to REG mapping or for different number of CORESET #0 symbols. For interleaved CCE to REG mapping, n_shift is dependent on cell ID. For non-interleaved CCE to REG mapping, n_shift is a specific value.

In accordance with aspects of the present disclosure, an example on the CORESET #0 configuration table design for 3 MHz channel BW is given in Table 8. Here 15PRB CORESET #0 is determined by puncturing

$${N}_{RB}^{CORESET} = 24 CORESET \#0 .$$

The different colors for 24PRBs CORESET #0 correspond to different CCE to REG mapping type.

TABLE 8
CORESET#0 configuration table for 3 MHz minimum channel BW

| Index | SS/PBCH block and CORESET multiplexing pattern | Number of RBs ${N}_{RB}^{CORESET}$ | Number of Symbols ${N}_{symb}^{CORESE}$ | Offset (RBs) |
|---|---|---|---|---|
| 0 | 1 | 12 | 2 | 0 |
| 1 | 1 | 12 | 3 | 0 |
| 2 | 1 | 24 | 2 | 2 |
| 3 | 1 | 24 | 2 | 3 |
| 4 | 1 | 24 | 2 | 4 |
| 5 | 1 | 24 | 3 | 0 |
| 6 | 1 | 24 | 3 | 1 |
| 7 | 1 | 24 | 3 | 2 |
| 8 | 1 | 24 | 3 | 3 |

| | |
|---|---|
| 9 | Reserved |
| 10 | Reserved |
| 11 | Reserved |
| 12 | Reserved |
| 13 | Reserved |
| 14 | Reserved |
| 15 | Reserved |

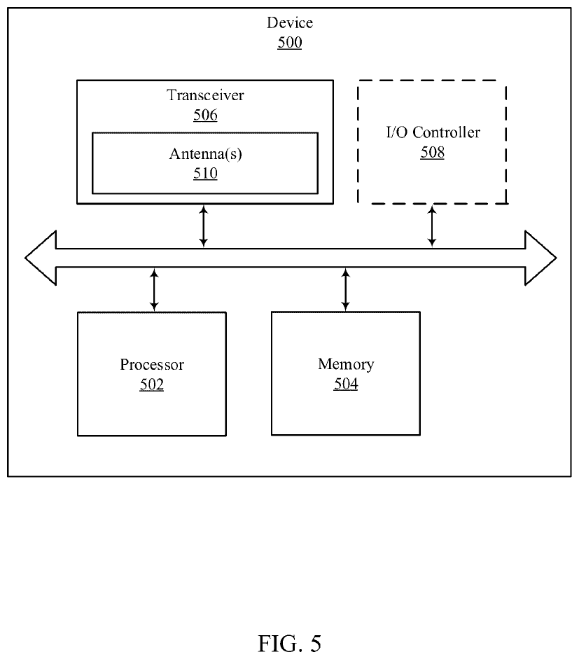

FIG. 5 illustrates an example of a device 500 that supports control resource set transmission in accordance with aspects of the present disclosure. The device 500 may be an example of a first apparatus 210 as described herein. The device 500 may support wireless communication with one or more network entities 102, UEs 104, or any combination thereof. The device 500 may include components for bi-directional communications including components for transmitting and receiving communications, such as a processor 502, a memory 504, a transceiver 506, and, optionally, an I/O controller 508. These components may be in electronic communication or otherwise coupled (e.g., operatively, communicatively, functionally, electronically, electrically) via one or more interfaces (e.g., buses).

The processor 502, the memory 504, the transceiver 506, or various combinations thereof or various components thereof may be examples of means for performing various aspects of the present disclosure as described herein. For example, the processor 502, the memory 504, the transceiver 506, or various combinations or components thereof may support a method for performing one or more of the operations described herein.

In some implementations, the processor 502, the memory 504, the transceiver 506, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 502 and the memory 504 coupled with the processor 502 may be configured to perform one or more of the functions described herein (e.g., executing, by the processor 502, instructions stored in the memory 504).

For example, the processor 502 may support wireless communication at the device 500 in accordance with examples as disclosed herein. The processor 502 may be configured to operable to support a means for receiving, via the transceiver, a configuration of a first control resource set (CORESET); determining a second CORESET based on the configuration and a predefined number of physical resource blocks (PRBs) to be punctured from the first CORESET; and determining, based on the configuration, a mapping type of control resource element (CCE) to resource element group (REG) mapping for the second CORESET. The processor 502 may be further configured to operable to support a means for other actions described in FIG. 2.

The processor 502 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 502 may be configured to operate a memory array using a memory controller. In some other implementations, a memory controller may be integrated into the processor 502. The processor 502 may be configured to execute computer-readable instructions stored in a memory (e.g., the memory 504) to cause the device 500 to perform various functions of the present disclosure.

The memory 504 may include random access memory (RAM) and read-only memory (ROM). The memory 504 may store computer-readable, computer-executable code including instructions that, when executed by the processor 502 cause the device 500 to perform various functions described herein. The code may be stored in a non-transitory computer-readable medium such as system memory or another type of memory. In some implementations, the code may not be directly executable by the processor 502 but may cause a computer (e.g., when compiled and executed) to perform functions described herein. In some implementations, the memory 504 may include, among other things, a basic I/O system (BIOS) which may control basic hardware or software operation such as the interaction with peripheral components or devices.

The I/O controller 508 may manage input and output signals for the device 500. The I/O controller 508 may also manage peripherals not integrated into the device M02. In some implementations, the I/O controller 508 may represent a physical connection or port to an external peripheral. In some implementations, the I/O controller 508 may utilize an operating system such as iOS®, ANDROID®, MS-WINDOWS®, OS/2®, UNIX®, LINUX®, or another known operating system.] n some implementations, the I/O controller 508 may be implemented as part of a processor, such as the processor 506. In some implementations, a user may interact with the device 500 via the I/O controller 508 or via hardware components controlled by the I/O controller 508.

In some implementations, the device 500 may include a single antenna 510. However, in some other implementations, the device 500 may have more than one antenna 510 (i.e., multiple antennas), including multiple antenna panels or antenna arrays, which may be capable of concurrently transmitting or receiving multiple wireless transmissions. The transceiver 506 may communicate bi-directionally, via the one or more antennas 510, wired, or wireless links as described herein. For example, the transceiver 506 may represent a wireless transceiver and may communicate bi-directionally with another wireless transceiver. The transceiver 506 may also include a modem to modulate the packets, to provide the modulated packets to one or more antennas 510 for transmission, and to demodulate packets received from the one or more antennas 510. The transceiver 506 may include one or more transmit chains, one or more receive chains, or a combination thereof.

A transmit chain may be configured to generate and transmit signals (e.g., control information, data, packets). The transmit chain may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmit chain may also include at least one power amplifier configured to amplify the modulated signal to an appropriate power level suitable for transmission over the wireless medium. The transmit chain may also include one or more antennas 510 for transmitting the amplified signal into the air or wireless medium.

A receive chain may be configured to receive signals (e.g., control information, data, packets) over a wireless medium. For example, the receive chain may include one or more antennas 510 for receive the signal over the air or wireless medium. The receive chain may include at least one amplifier (e.g., a low-noise amplifier (LNA)) configured to amplify the received signal. The receive chain may include at least one demodulator configured to demodulate the receive signal and obtain the transmitted data by reversing the modulation technique applied during transmission of the signal. The receive chain may include at least one decoder for decoding the processing the demodulated signal to receive the transmitted data.

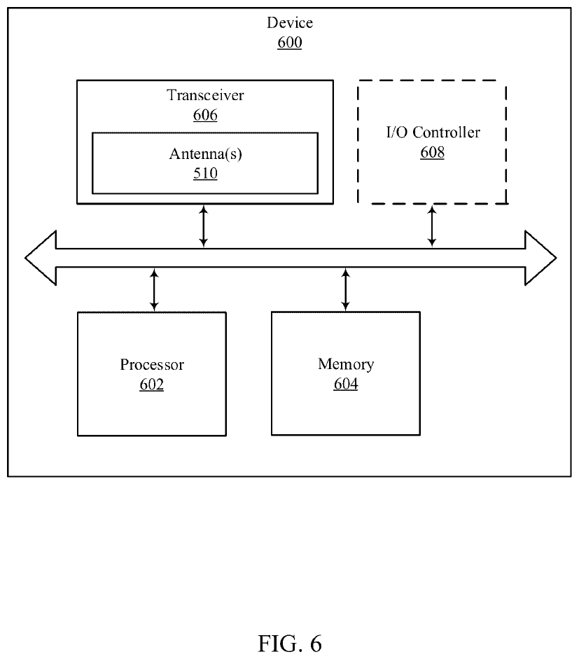

FIG. 6 illustrates an example of a device 600 that supports control resource set transmission in accordance with aspects of the present disclosure. The device 600 may be an example of a second apparatus 220 as described herein. The device 600 may support wireless communication with one or more network entities 102, UEs 104, or any combination thereof. The device 600 may include components for bi-directional communications including components for transmitting and receiving communications, such as a processor 602, a memory 604, a transceiver 606, and, optionally, an I/O controller 608. These components may be in electronic communication or otherwise coupled (e.g., operatively, communicatively, functionally, electronically, electrically) via one or more interfaces (e.g., buses).

The processor 602, the memory 604, the transceiver 606, or various combinations thereof or various components thereof may be examples of means for performing various aspects of the present disclosure as described herein. For example, the processor 602, the memory 604, the transceiver 606, or various combinations or components thereof may support a method for performing one or more of the operations described herein.

In some implementations, the processor 602, the memory 604, the transceiver 606, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 602 and the memory 604 coupled with the processor 602 may be configured to perform one or more of the functions described herein (e.g., executing, by the processor 602, instructions stored in the memory 604).

For example, the processor 602 may support wireless communication at the device 600 in accordance with examples as disclosed herein. The processor 602 may be configured to operable to support a means for transmitting, via the transceiver to a terminal device, a configuration of a first control resource set (CORESET); determining a second CORESET based on the configuration and a predefined number of physical resource blocks (PRBs) to be punctured from the first CORESET; and determining, based on the configuration, a mapping type of control resource element (CCE) to resource element group (REG) mapping for the second CORESET. The processor 602 may be further configured to operable to support a means for other actions described in FIG. 2.

The processor 602 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 602 may be configured to operate a memory array using a memory controller. In some other implementations, a memory controller may be integrated into the processor 602. The processor 602 may be configured to execute computer-readable instructions stored in a memory (e.g., the memory 604) to cause the device 600 to perform various functions of the present disclosure.

The memory 604 may include random access memory (RAM) and read-only memory (ROM). The memory 604 may store computer-readable, computer-executable code including instructions that, when executed by the processor 602 cause the device 600 to perform various functions described herein. The code may be stored in a non-transitory computer-readable medium such as system memory or another type of memory. In some implementations, the code may not be directly executable by the processor 602 but may cause a computer (e.g., when compiled and executed) to perform functions described herein. In some implementations, the memory 604 may include, among other things, a basic I/O system (BIOS) which may control basic hardware or software operation such as the interaction with peripheral components or devices.

The I/O controller 608 may manage input and output signals for the device 600. The I/O controller 608 may also manage peripherals not integrated into the device M02. In some implementations, the I/O controller 608 may represent a physical connection or port to an external peripheral. In some implementations, the I/O controller 608 may utilize an operating system such as iOS®, ANDROID®, MS-WINDOWS®, OS/2®, UNIX®, LINUX®, or another known operating system. In some implementations, the I/O controller 608 may be implemented as part of a processor, such as the processor 606. In some implementations, a user may interact with the device 600 via the I/O controller 608 or via hardware components controlled by the I/O controller 608.

In some implementations, the device 600 may include a single antenna 610. However, in some other implementations, the device 600 may have more than one antenna 610 (i.e., multiple antennas), including multiple antenna panels or antenna arrays, which may be capable of concurrently transmitting or receiving multiple wireless transmissions. The transceiver 606 may communicate bi-directionally, via the one or more antennas 610, wired, or wireless links as described herein. For example, the transceiver 606 may represent a wireless transceiver and may communicate bi-directionally with another wireless transceiver. The transceiver 606 may also include a modem to modulate the packets, to provide the modulated packets to one or more antennas 610 for transmission, and to demodulate packets received from the one or more antennas 610. The transceiver 606 may include one or more transmit chains, one or more receive chains, or a combination thereof.

A transmit chain may be configured to generate and transmit signals (e.g., control information, data, packets). The transmit chain may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmit chain may also include at least one power amplifier configured to amplify the modulated signal to an appropriate power level suitable for transmission over the wireless medium. The transmit chain may also include one or more antennas 610 for transmitting the amplified signal into the air or wireless medium.

A receive chain may be configured to receive signals (e.g., control information, data, packets) over a wireless medium. For example, the receive chain may include one or more antennas 610 for receive the signal over the air or wireless medium. The receive chain may include at least one amplifier (e.g., a low-noise amplifier (LNA)) configured to amplify the received signal. The receive chain may include at least one demodulator configured to demodulate the receive signal and obtain the transmitted data by reversing the modulation technique applied during transmission of the signal. The receive chain may include at least one decoder for decoding the processing the demodulated signal to receive the transmitted data.

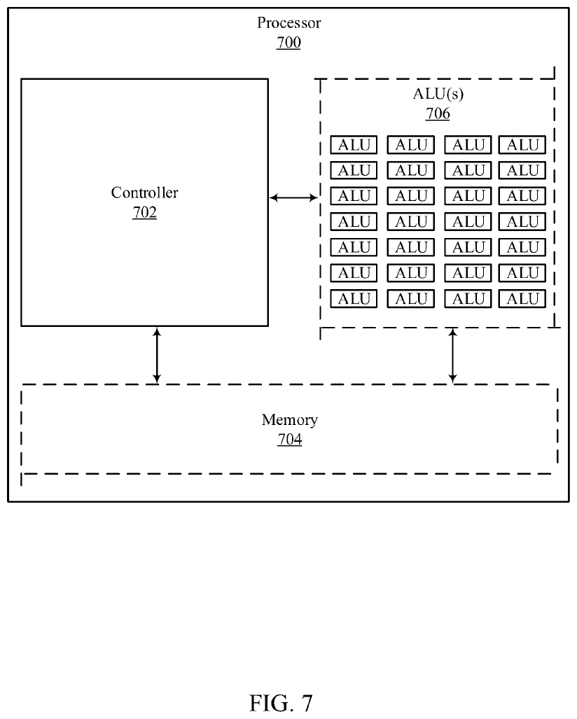

FIG. 7 illustrates an example of a processor 700 that supports control resource set transmission in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704. Additionally, or alternatively, the processor 700 may optionally include one or more arithmetic-logic units (ALUs) 700. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementation, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions (e.g., functions or tasks supporting transmit power prioritization). For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 700 may be configured to support various operations in accordance with examples as described herein. In some implementation, the one or more ALUs 700 may reside within or on a processor chipset (e.g., the processor 700). In some other implementations, the one or more ALUs 700 may reside external to the processor chipset (e.g., the processor 700). One or more ALUs 700 may perform one or more computations such as addition, subtraction, multiplication, and division on data. For example, one or more ALUs 700 may receive input operands and an operation code, which determines an operation to be executed. One or more ALUs 700 be configured with a variety of logical and arithmetic circuits, including adders, subtractors, shifters, and logic gates, to process and manipulate the data according to the operation. Additionally, or alternatively, the one or more ALUs 700 may support logical operations such as AND, OR, exclusive-OR (XOR), not-OR (NOR), and not-AND (NAND), enabling the one or more ALUs 700 to handle conditional operations, comparisons, and bitwise operations.

The processor 700 may support wireless communication in accordance with examples as disclosed herein. The processor 702 may be configured to or operable to support a means for receiving, via the transceiver, a configuration of a first control resource set (CORESET); determining a second CORESET based on the configuration and a predefined number of physical resource blocks (PRBs) to be punctured from the first CORESET; and determining, based on the configuration, a mapping type of control resource element (CCE) to resource element group (REG) mapping for the second CORESET. The processor 502 may be further configured to operable to support a means for other actions described in FIG. 2.

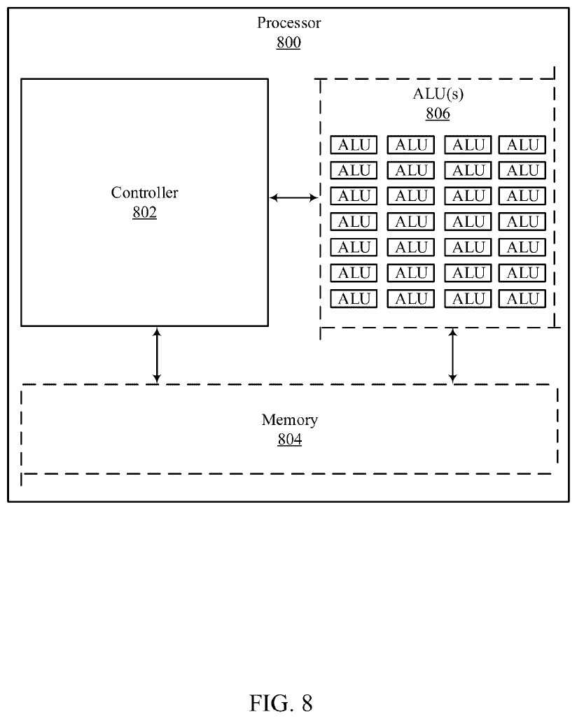

FIG. 8 illustrates an example of a processor 800 that supports control resource set transmission in accordance with aspects of the present disclosure. The processor 800 may be an example of a processor configured to perform various operations in accordance with examples as described herein. The processor 800 may include a controller 802 configured to perform various operations in accordance with examples as described herein. The processor 800 may optionally include at least one memory 804. Additionally, or alternatively, the processor 800 may optionally include one or more arithmetic-logic units (ALUs) 800. One or more of these components may be in electronic communication, or otherwise coupled (e.g., operatively, communicatively, functionally, electronically, electrically) via one or more interfaces (e.g., buses).

The processor 800 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 800) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 802 may be configured to manage and coordinate various operations (e.g., signaling, receiving, obtaining, retrieving, transmitting, outputting, forwarding, storing, determining, identifying, accessing, writing, reading) of the processor 800 to cause the processor 800 to support various operations in accordance with examples as described herein. For example, the controller 802 may operate as a control unit of the processor 800, generating control signals that manage the operation of various components of the processor 800. These control signals include enabling or disabling functional units, selecting data paths, initiating memory access, and coordinating timing of operations.

The controller 802 may be configured to fetch (e.g., obtain, retrieve, receive) instructions from the memory 804 and determine subsequent instruction(s) to be executed to cause the processor 800 to support various operations in accordance with examples as described herein. The controller 802 may be configured to track memory address of instructions associated with the memory 804. The controller 802 may be configured to decode instructions to determine the operation to be performed and the operands involved. For example, the controller 802 may be configured to interpret the instruction and determine control signals to be output to other components of the processor 800 to cause the processor 800 to support various operations in accordance with examples as described herein. Additionally, or alternatively, the controller 802 may be configured to manage flow of data within the processor 800. The controller 802 may be configured to control transfer of data between registers, arithmetic logic units (ALUs), and other functional units of the processor 800.

The memory 804 may include one or more caches (e.g., memory local to or included in the processor 800 or other memory, such RAM, ROM, DRAM, SDRAM, SRAM, MRAM, flash memory, etc. In some implementation, the memory 804 may reside within or on a processor chipset (e.g., local to the processor 800). In some other implementations, the memory 804 may reside external to the processor chipset (e.g., remote to the processor 800).

The memory 804 may store computer-readable, computer-executable code including instructions that, when executed by the processor 800, cause the processor 800 to perform various functions described herein. The code may be stored in a non-transitory computer-readable medium such as system memory or another type of memory. The controller 802 and/or the processor 800 may be configured to execute computer-readable instructions stored in the memory 804 to cause the processor 800 to perform various functions (e.g., functions or tasks supporting transmit power prioritization). For example, the processor 800 and/or the controller 802 may be coupled with or to the memory 804, the processor 800, the controller 802, and the memory 804 may be configured to perform various functions described herein. In some examples, the processor 800 may include multiple processors and the memory 804 may include multiple memories. One or more of the multiple processors may be coupled with one or more of the multiple memories, which may, individually or collectively, be configured to perform various functions herein.

The one or more ALUs 800 may be configured to support various operations in accordance with examples as described herein. In some implementation, the one or more ALUs 800 may reside within or on a processor chipset (e.g., the processor 800). In some other implementations, the one or more ALUs 800 may reside external to the processor chipset (e.g., the processor 800). One or more ALUs 800 may perform one or more computations such as addition, subtraction, multiplication, and division on data. For example, one or more ALUs 800 may receive input operands and an operation code, which determines an operation to be executed. One or more ALUs 800 be configured with a variety of logical and arithmetic circuits, including adders, subtractors, shifters, and logic gates, to process and manipulate the data according to the operation. Additionally, or alternatively, the one or more ALUs 800 may support logical operations such as AND, OR, exclusive-OR (XOR), not-OR (NOR), and not-AND (NAND), enabling the one or more ALUs 800 to handle conditional operations, comparisons, and bitwise operations.

The processor 800 may support wireless communication in accordance with examples as disclosed herein. The processor 802 may be configured to or operable to support a means for transmitting, via the transceiver to a terminal device, a configuration of a first control resource set (CORESET); determining a second CORESET based on the configuration and a predefined number of physical resource blocks (PRBs) to be punctured from the first CORESET; and determining, based on the configuration, a mapping type of control resource element (CCE) to resource element group (REG) mapping for the second CORESET. The processor 602 may be further configured to operable to support a means for other actions described in FIG. 2.

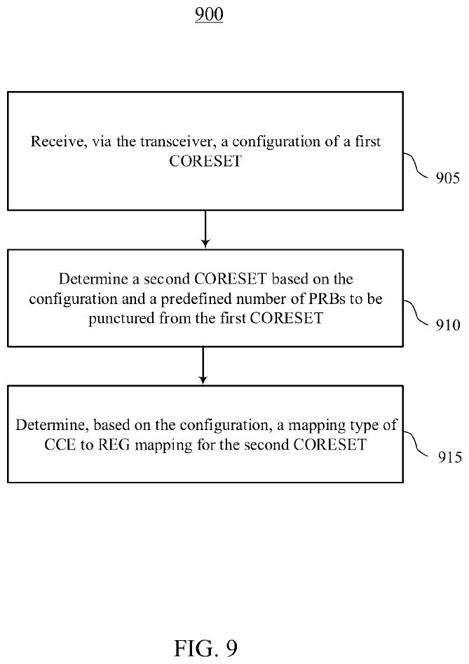

FIG. 9 illustrates a flowchart of a method 900 that supports control resource set transmission in accordance with aspects of the present disclosure. The operations of the method 900 may be implemented by a device or its components as described herein. For example, the operations of the method 900 may be performed by a first apparatus 210 as described herein. In some implementations, the device may execute a set of instructions to control the function elements of the device to perform the described functions. Additionally, or alternatively, the device may perform aspects of the described functions using special-purpose hardware.

At 905, the method includes receiving, via the transceiver, a configuration of a first CORESET. The operations of 905 may be performed in accordance with examples as described herein. In some implementations, aspects of the operations of 905 may be performed by a device as described with reference to FIG. 1A.

At 910, the method includes determining a second CORESET based on the configuration and a predefined number of PRBs to be punctured from the first CORESET. The operations of 910 may be performed in accordance with examples as described herein. In some implementations, aspects of the operations of 910 may be performed by a device as described with reference to FIG. 1A.

At 915, the method includes determining, based on the configuration, a mapping type of CCE to REG mapping for the second CORESET. The operations of 915 may be performed in accordance with examples as described herein. In some implementations, aspects of the operations of 915 may be performed by a device as described with reference to FIG. 1A.

In some embodiment, the configuration may comprise a PRB offset indicative of one of the following: a first frequency gap between a unpunctured synchronization signal block (SSB) and the first CORESET; or a second frequency gap between a punctured SSB and the first CORESET.

In some embodiment, the method may further include determining a frequency position of the second CORESET, based on the PRB offset, the predefined number of PRBs to be punctured from the first CORESET, and a frequency position of the unpunctured SSB.

In some embodiment, the PRB offset may be selected from a set of candidate PRB offsets, and the set of candidate PRB offsets may be determined based on the predefined number of PRBs to be punctured from the first CORESET.

In some embodiment, the predefined number of PRBs to be punctured from the first CORESET in the case that the first CORESET comprises 2 symbols may be the same as or different from the predefined number of PRBs to be punctured from the first CORESET in the case that the first CORESET comprises 3 symbols.

In some embodiment, determining the second CORESET may comprise one of the following: puncturing lowest 2 CCEs or lowest 6 PRBs of the first CORESET in the case that the first CORESET comprises 2 symbols; or puncturing the lowest 2 CCEs or lowest 4 PRBs of the first CORESET in the case that the first CORESET comprises 3 symbols.

In some embodiment, determining the mapping type may comprise: determining the mapping type as interleaved CCE to REG mapping or non-interleaved CCE to REG mapping based on the number of symbols of the first CORESET.

In some embodiment, determining the mapping type based on the number of symbols may comprise one of the following: determining the mapping type as the interleaved CCE to REG mapping in the case that the number of symbols is 2; or determining the mapping type as the non-interleaved CCE to REG mapping in the case that the number of symbols is 3.

In some embodiment, the method may further include determining, based on the configuration, a shift value for the CCE-to-REG mapping for the second CORESET.

In some embodiment, determining the shift value may comprise: determining the shift value based on the mapping type or the number of symbols of the first CORESET.

In some embodiment, determining the shift value based on the mapping type may comprise one of the following: determining the shift value as an identifier (ID) of a cell in which the configuration of the first CORESET is received in the case that the mapping type is interleaved CCE to REG mapping; or determining the shift value as a predetermined value in the case that the mapping type is non-interleaved CCE to REG mapping.

In some embodiment, determining the shift value based on the number of symbols may comprise one of the following: determining the shift value as an ID of a cell in which the configuration of the first CORESET is received in the case that the number of symbols is 2; or determining the shift value as a predetermined value in the case that the number of symbols is 3.

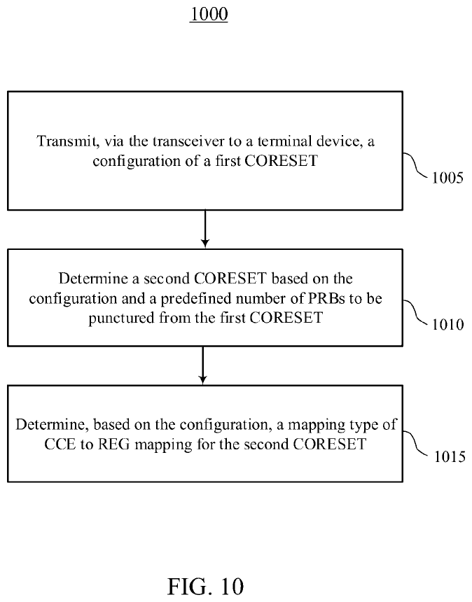

FIG. 10 illustrates a flowchart of a method 1000 that supports control resource set transmission in accordance with aspects of the present disclosure. The operations of the method 1000 may be implemented by a device or its components as described herein. For example, the operations of the method 1000 may be performed by a second apparatus 220 as described herein. In some implementations, the device may execute a set of instructions to control the function elements of the device to perform the described functions. Additionally, or alternatively, the device may perform aspects of the described functions using special-purpose hardware.

At 1005, the method includes transmitting, via the transceiver to a terminal device, a configuration of a first CORESET. The operations of 1005 may be performed in accordance with examples as described herein. In some implementations, aspects of the operations of may be performed by a device as described with reference to FIG. 1A.

At 1110, the method includes determining a second CORESET based on the configuration and a predefined number of PRBs to be punctured from the first CORESET. The operations of 1110 may be performed in accordance with examples as described herein. In some implementations, aspects of the operations of 1110 may be performed by a device as described with reference to FIG. 1A.

At 1115, the method includes determining, based on the configuration, a mapping type of CCE to REG mapping for the second CORESET. The operations of 1115 may be performed in accordance with examples as described herein. In some implementations, aspects of the operations of 1115 may be performed by a device as described with reference to FIG. 1A.

In some embodiment, the configuration may comprise a PRB offset indicative of one of the following: a first frequency gap between a unpunctured synchronization signal block (SSB) and the first CORESET; or a second frequency gap between a punctured SSB and the first CORESET.

In some embodiment, the method may further include determining a frequency position of the second CORESET, based on the PRB offset, the predefined number of PRBs to be punctured from the first CORESET, and a frequency position of the unpunctured SSB.

Some implementations of the method and apparatuses described herein may further include determining a set of candidate PRB offsets based on the predefined number of PRBs to be punctured from the first CORESET; and selecting the PRB offset from the set of candidate PRB offsets.

In some embodiment, the predefined number of PRBs to be punctured from the first CORESET in the case that the first CORESET comprises 2 symbols may be the same as or different from the predefined number of PRBs to be punctured from the first CORESET in the case that the first CORESET comprises 3 symbols.

In some embodiment, determining the second CORESET may comprise one of the following: determining that lowest 2 CCEs or lowest 6 PRBs of the first CORESET are to be punctured in the case that the first CORESET comprises 2 symbols; or determining that the lowest 2 CCEs or lowest 4 PRBs of the first CORESET are to be punctured in the case that the first CORESET comprises 3 symbols.

In some embodiment, determining the mapping type may comprise: determining the mapping type as interleaved CCE to REG mapping or non-interleaved CCE to REG mapping based on the number of symbols of the first CORESET.

In some embodiment, determining the mapping type based on the number of symbols may comprise one of the following: determining the mapping type as the interleaved CCE to REG mapping in the case that the number of symbols is 2; or determining the mapping type as the non-interleaved CCE to REG mapping in the case that the number of symbols is 3.

In some embodiment, the method may further include determining, based on the configuration, a shift value for the CCE-to-REG mapping for the second CORESET.

In some embodiment, determining the shift value may comprise: determining the shift value based on the mapping type or the number of symbols of the first CORESET.

In some embodiment, determining the shift value based on the mapping type may comprise one of the following: determining the shift value as an identifier (ID) of a cell in which the configuration of the first CORESET is transmitted in the case that the mapping type is interleaved CCE to REG mapping; or determining the shift value as a predetermined value in the case that the mapping type is non-interleaved CCE to REG mapping.

In some embodiment, determining the shift value based on the number of symbols may comprise one of the following: determining the shift value as an ID of a cell in which the configuration of the first CORESET is transmitted in the case that the number of symbols is 2; or determining the shift value as a predetermined value in the case that the number of symbols is 3.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

The embodiments of the present disclosure may further be described using the following clauses.
Clause 1. A first apparatus for wireless communication comprising: a processor; and a transceiver coupled to the processor, wherein the processor is configured to: receive, via the transceiver, a configuration of a first control resource set (CORESET); determine a second CORESET based on the configuration and a predefined number of physical resource blocks (PRBs) to be punctured from the first CORESET; and determine, based on the configuration, a mapping type of control resource element (CCE) to resource element group (REG) mapping for the second CORESET.
Clause 2. The first apparatus of clause 1, wherein the configuration comprises a PRB offset indicative of one of the following: a first frequency gap between a unpunctured synchronization signal block (SSB) and the first CORESET; or a second frequency gap between a punctured SSB and the first CORESET.
Clause 3. The first apparatus of clause 2, wherein the processor is further configured to: determine a frequency position of the second CORESET, based on the PRB offset, the predefined number of PRBs to be punctured from the first CORESET, and a frequency position of the unpunctured SSB.
Clause 4. The first apparatus of clause 2, wherein the PRB offset is selected from a set of candidate PRB offsets, and the set of candidate PRB offsets is determined based on the predefined number of PRBs to be punctured from the first CORESET.
Clause 5. The first apparatus of clause 1, wherein the predefined number of PRBs to be punctured from the first CORESET in the case that the first CORESET comprises 2 symbols is the same as or different from the predefined number of PRBs to be punctured from the first CORESET in the case that the first CORESET comprises 3 symbols.
Clause 6. The first apparatus of clause 1, wherein determining the second CORESET comprises one of the following: puncturing lowest 2 CCEs or lowest 6 PRBs of the first CORESET in the case that the first CORESET comprises 2 symbols; or puncturing the lowest 2 CCEs or lowest 4 PRBs of the first CORESET in the case that the first CORESET comprises 3 symbols.
Clause 7. The first apparatus of clause 1, wherein determining the mapping type comprises: determining the mapping type as interleaved CCE to REG mapping or non-interleaved CCE to REG mapping based on the number of symbols of the first CORESET.
Clause 8. The first apparatus of clause 7, wherein determining the mapping type based on the number of symbols comprises one of the following: determining the mapping type as the interleaved CCE to REG mapping in the case that the number of symbols is 2; or determining the mapping type as the non-interleaved CCE to REG mapping in the case that the number of symbols is 3.
Clause 9. The first apparatus of any of clauses 1-8, wherein the processor is further configured to: determine, based on the configuration, a shift value for the CCE-to-REG mapping for the second CORESET.
Clause 10. The first apparatus of clause 9, wherein determining the shift value comprises: determining the shift value based on the mapping type or the number of symbols of the first CORESET.
Clause 11. The first apparatus of clause 10, wherein determining the shift value based on the mapping type comprises one of the following: determining the shift value as an identifier (ID) of a cell in which the configuration of the first CORESET is received in the case that the mapping type is interleaved CCE to REG mapping; or determining the shift value as a predetermined value in the case that the mapping type is non-interleaved CCE to REG mapping.
Clause 12. The first apparatus of clause 10, wherein determining the shift value based on the number of symbols comprises one of the following: determining the shift value as an ID of a cell in which the configuration of the first CORESET is received in the case that the number of symbols is 2; or determining the shift value as a predetermined value in the case that the number of symbols is 3.
Clause 13. A second apparatus for wireless communication comprising: a processor; and a transceiver coupled to the processor, wherein the processor is configured to: transmit, via the transceiver to a first apparatus, a configuration of a first control resource set (CORESET); determine a second CORESET based on the configuration and a predefined number of physical resource blocks (PRBs) to be punctured from the first CORESET; and determine, based on the configuration, a mapping type of control resource element (CCE) to resource element group (REG) mapping for the second CORESET.
Clause 14. The second apparatus of clause 13, wherein the configuration comprises a PRB offset indicative of one of the following: a first frequency gap between a unpunctured synchronization signal block (SSB) and the first CORESET; or a second frequency gap between a punctured SSB and the first CORESET.
Clause 15. The second apparatus of clause 14, wherein the processor is further configured to: determine a frequency position of the second CORESET, based on the PRB offset, the predefined number of PRBs to be punctured from the first CORESET, and a frequency position of the unpunctured SSB.
Clause 16. The second apparatus of clause 14, wherein the processor is further configured to: determine a set of candidate PRB offsets based on the predefined number of PRBs to be punctured from the first CORESET; and select the PRB offset from the set of candidate PRB offsets.
Clause 17. The second apparatus of clause 13, wherein the predefined number of PRBs to be punctured from the first CORESET in the case that the first CORESET comprises 2 symbols is the same as or different from the predefined number of PRBs to be punctured from the first CORESET in the case that the first CORESET comprises 3 symbols.
Clause 18. The second apparatus of clause 13, wherein determining the second CORESET comprises one of the following: determining that lowest 2 CCEs or lowest 6 PRBs of the first CORESET are to be punctured in the case that the first CORESET comprises 2 symbols; or determining that the lowest 2 CCEs or lowest 4 PRBs of the first CORESET are to be punctured in the case that the first CORESET comprises 3 symbols.
Clause 19. The second apparatus of clause 13, wherein determining the mapping type comprises: determining the mapping type as interleaved CCE to REG mapping or non-interleaved CCE to REG mapping based on the number of symbols of the first CORESET.
Clause 20. The second apparatus of clause 19, wherein determining the mapping type based on the number of symbols comprises one of the following: determining the mapping type as the interleaved CCE to REG mapping in the case that the number of symbols is 2; or determining the mapping type as the non-interleaved CCE to REG mapping in the case that the number of symbols is 3.
Clause 21. The second apparatus of any of clause 13-20, wherein the processor is further configured to: determine, based on the configuration, a shift value for the CCE-to-REG mapping for the second CORESET.
Clause 22. The second apparatus of clause 21, wherein determining the shift value comprises: determining the shift value based on the mapping type or the number of symbols of the first CORESET.
Clause 23. The second apparatus of clause 22, wherein determining the shift value based on the mapping type comprises one of the following: determining the shift value as an identifier (ID) of a cell in which the configuration of the first CORESET is transmitted in the case that the mapping type is interleaved CCE to REG mapping; or determining the shift value as a predetermined value in the case that the mapping type is non-interleaved CCE to REG mapping.
Clause 24. The second apparatus of clause 22, wherein determining the shift value based on the number of symbols comprises one of the following: determining the shift value as an ID of a cell in which the configuration of the first CORESET is transmitted in the case that the number of symbols is 2; or determining the shift value as a predetermined value in the case that the number of symbols is 3.
Clause 25. A processor for wireless communication, comprising: at least one memory; and a controller coupled with the at least one memory and configured to cause the controller to: receive, via the transceiver, a configuration of a first control resource set (CORESET); determine a second CORESET based on the configuration and a predefined number of physical resource blocks (PRBs) to be punctured from the first CORESET; and determine, based on the configuration, a mapping type of control resource element (CCE) to resource element group (REG) mapping for the second CORESET.
Clause 26. A processor for wireless communication, comprising: at least one memory; and a controller coupled with the at least one memory and configured to cause the controller to: transmit, via the transceiver to a first apparatus, a configuration of a first control resource set (CORESET); determine a second CORESET based on the configuration and a predefined number of physical resource blocks (PRBs) to be punctured from the first CORESET; and determine, based on the configuration, a mapping type of control resource element (CCE) to resource element group (REG) mapping for the second CORESET.
Clause 27. A method performed by a first apparatus, comprising: receive, via the transceiver, a configuration of a first control resource set (CORESET); determine a second CORESET based on the configuration and a predefined number of physical resource blocks (PRBs) to be punctured from the first CORESET; and determine, based on the configuration, a mapping type of control resource element (CCE) to resource element group (REG) mapping for the second CORESET.
Clause 28. A method performed by a second apparatus, comprising: transmit, via the transceiver to a first apparatus, a configuration of a first control resource set (CORESET); determine a second CORESET based on the configuration and a predefined number of physical resource blocks (PRBs) to be punctured from the first CORESET; and determine, based on the configuration, a mapping type of control resource element (CCE) to resource element group (REG) mapping for the second CORESET.
Clause 29. A computer readable medium having instructions stored thereon, the instructions, when executed by a processor of an apparatus, causing the apparatus to perform at least the method of clause 27 or 28.

1. A first apparatus for wireless communication, comprising:
at least one memory; and
at least one processor coupled with the at least one memory and configured to cause the first apparatus to:
receive a configuration of a first control resource set (CORESET);
determine a second CORESET based on the configuration and a predefined number of physical resource blocks (PRBs) to be punctured from the first CORESET; and
determine, based on the configuration, a mapping type of control resource element (CCE) to resource element group (REG) mapping for the second CORESET.

2. The first apparatus of claim 1, wherein the configuration comprises a PRB offset indicative of:
a first frequency gap between a unpunctured synchronization signal block (SSB) and the first CORESET; or
a second frequency gap between a punctured SSB and the first CORESET.

3. The first apparatus of claim 2, wherein the at least one processor is further configured to cause the first apparatus to:
determine a frequency position of the second CORESET, based on the PRB offset, the predefined number of PRBs to be punctured from the first CORESET, and a frequency position of the unpunctured SSB.

4. The first apparatus of claim 2, wherein the PRB offset is selected from a set of candidate PRB offsets, and the set of candidate PRB offsets is determined based on the predefined number of PRBs to be punctured from the first CORESET.

5. The first apparatus of claim 1, wherein the predefined number of PRBs to be punctured from the first CORESET in the case that the first CORESET comprises 2 symbols is the same as or different from the predefined number of PRBs to be punctured from the first CORESET when the first CORESET comprises 3 symbols.

6. The first apparatus of claim 1, wherein the at least one processor is configured to cause the first apparatus to determine the second CORESET by:
puncturing lowest 2 CCEs or lowest 6 PRBs of the first CORESET when the first CORESET comprises 2 symbols; or
puncturing the lowest 2 CCEs or lowest 4 PRBs of the first CORESET when the first CORESET comprises 3 symbols.

7. The first apparatus of claim 1, wherein the at least one processor is configured to cause the first apparatus to determine the mapping type by:
determining the mapping type as interleaved CCE to REG mapping or non-interleaved CCE to REG mapping based on the number of symbols of the first CORESET.

8. The first apparatus of claim 7, wherein the at least one processor is configured to cause the first apparatus to determine the mapping type based on the number of symbols by:
determining the mapping type as the interleaved CCE to REG mapping when the number of symbols is 2; or
determining the mapping type as the non-interleaved CCE to REG mapping in when the number of symbols is 3.

9. The first apparatus of claim 1, wherein the at least one processor is further configured to cause the first apparatus to:
determine, based on the configuration, a shift value for the CCE-to-REG mapping for the second CORESET.

10. The first apparatus of claim 9, wherein the at least one processor is further configured to cause the first apparatus to determine the shift value by:
determining the shift value based on the mapping type or the number of symbols of the first CORESET.

11. The first apparatus of claim 10, wherein the at least one processor is further configured to cause the first apparatus to determine the shift value based on the mapping type by:
determining the shift value as an identifier (ID) of a cell in which the configuration of the first CORESET is received when the mapping type is interleaved CCE to REG mapping; or
determining the shift value as a predetermined value when the mapping type is non-interleaved CCE to REG mapping.

12. The first apparatus of claim 10, wherein the at least one processor is further configured to cause the first apparatus to determine the shift value based on the number of symbols by:
determining the shift value as an ID of a cell in which the configuration of the first CORESET is received when the number of symbols is 2; or
determining the shift value as a predetermined value when the number of symbols is 3.

13. A second apparatus for wireless communication, comprising:
at least one memory; and
at least one processor coupled with the at least one memory and is configured to cause the second apparatus to:
transmit, to a first apparatus, a configuration of a first control resource set (CORESET);
determine a second CORESET based on the configuration and a predefined number of physical resource blocks (PRBs) to be punctured from the first CORESET; and
determine, based on the configuration, a mapping type of control resource element (CCE) to resource element group (REG) mapping for the second CORESET.

14. The second apparatus of claim 13, wherein the predefined number of PRBs to be punctured from the first CORESET when the first CORESET comprises 2 symbols is the same as or different from the predefined number of PRBs to be punctured from the first CORESET when the first CORESET comprises 3 symbols.

15. The second apparatus of claim 13, wherein the at least one processor is further configured to cause the second apparatus to determine the second CORESET by:
determining that lowest 2 CCEs or lowest 6 PRBs of the first CORESET are to be punctured when the first CORESET comprises 2 symbols; or
determining that the lowest 2 CCEs or lowest 4 PRBs of the first CORESET are to be punctured when the first CORESET comprises 3 symbols.

16. The second apparatus of claim 13, wherein the at least one processor is further configured to cause the second apparatus to determine the mapping type by:
determining the mapping type as interleaved CCE to REG mapping or non-interleaved CCE to REG mapping based on the number of symbols of the first CORESET.

17. The second apparatus of claim 13, wherein the at least one processor is further configured to cause the second apparatus to:
determine, based on the configuration, a shift value for the CCE-to-REG mapping for the second CORESET.

18. The second apparatus of claim 17, wherein the at least one processor is further configured to cause the second apparatus to determine the shift value by:
determining the shift value based on the mapping type or the number of symbols of the first CORESET.

19. A method performed by a first apparatus, the method comprising:
receiving a configuration of a first control resource set (CORESET);
determining a second CORESET based on the configuration and a predefined number of physical resource blocks (PRBs) to be punctured from the first CORESET; and
determining, based on the configuration, a mapping type of control resource element (CCE) to resource element group (REG) mapping for the second CORESET.

20. A method performed by a second apparatus, the method comprising:
transmitting, to a first apparatus, a configuration of a first control resource set (CORESET);
determining a second CORESET based on the configuration and a predefined number of physical resource blocks (PRBs) to be punctured from the first CORESET; and
determining, based on the configuration, a mapping type of control resource element (CCE) to resource element group (REG) mapping for the second CORESET.
